(19) United States
(12) Patent Application Publication
(10) Pub. No.: US 2007/0122726 A1
(43) Pub. Date: May 31, 2007

(54) SINGLE-COMPONENT MAGNETIC TONER AND DEVELOPING UNIT AND IMAGE FORMING APPARATUS USING THE TONER

(75) Inventors: Hiroshi Mizuhata, Wakayama-shi, Wakayama (JP); Yukinori Nakayama, Chuo-ku, Osaka (JP)

Correspondence Address: ROSSI, KIMMS & McDOWELL LLP., P.O. BOX 826, ASHBURN, VA, 20146-0826, US

(73) Assignee: KYOCERA MITA CORPORATION, Osaka (JP)

(21) Appl. No.: 11/537,440

(22) Filed: Sep. 29, 2006

(30) Foreign Application Priority Data
Sep. 30, 2005 (JP) 2005-289329
Sep. 30, 2005 (JP) 2005-289330

(51) Int. Cl. G03G 9/083

(52) U.S. Cl. 430/106.1; 430/111.41; 430/122

(57) ABSTRACT

The invention aims to provide magnetic single-component toner of which externally added magnetic powder is not buried into the toner even when the toner has experienced stress due to use and thermal stress, which is superior in stability of electrostatic charge and allow images without lack in parts of the image to be formed stably, and with which occurrence of a filming phenomenon of the photoreceptor drum and dielectric breakdown due to charge leaks to the photoreceptor drum are prevented and stable formation of thin layer of toner on the developing sleeve for a long period can be secured, and to provide a developing unit and image forming apparatus using the toner.

The magnetic single-component toner contains in its binder resin at least magnetic powder, and externally added with magnetic powder of basically polyhedral grain shape with apexes and ridges being rounded to be formed into curved surfaces such that portions deemed as straight lines remain on the circumference of the projected figure of the grain, and said magnetic powder externally added is of volume specific resistance of in a range of 10²-10⁹ Ωcm.

### BACKGROUND OF THE INVENTION

1. Field of the Invention

The present invention relates to magnetic single-component toner containing magnetic powder in a binder resin used in image forming apparatuses such as laser printers, electrostatic copy-machines, plain paper facsimiles, and complex machines, and a developing unit and image forming apparatus for developing a latent image on a latent image carrying body into a visible toner image.

2. Description of the Related Art

In recent years, laser printers, electrostatic copy-machines, plain paper facsimiles, and complex machines of these utilizing an electrophotographic method, etc. have been remarkably increased in printing speed, reduced in machine size, and increased in operation life of machines. High resolution, high image quantity, and high durability are required to these machines as a matter of course, and toner of stable charging characteristics is indispensable to obtain good image characteristics and its durability to comply with increase printing speed. Therefore, toner is demanded with which a stable thin layer of toner can be formed for a long period and each process of image forming is not affected and further particularly a photoreceptor drum which has an decisive influence on the quality of the image is little affected.

In a laser printer, electrostatic copy-machine, plain paper facsimile and complex machine of these utilizing an electrophotographic method, etc. first the surface of a latent carrying body (photoreceptor) is charged uniformly by a charging means, then a latent image is formed by exposure by means of an exposing means such as a semi-conductor laser, light-emitting diode, etc., then the latent image is developed or reversely developed to obtain a visible toner image, then the toner image is transferred to the surface of a recording medium such as a sheet of paper directly, or the toner image is transferred to the surface of an intermediate transfer body and then transferred to the surface of a recording medium such as a sheet of paper, then the transferred image on the recording medium is fused by a fusing means to finish the sequence of image forming process.

As toner for the image forming process, toner of average grain size of 5-15 μm is generally used which is obtained by mixing dyestuff or pigment as a charge control agent, wax as a parting agent, and magnetic material with thermoplastic resin as a binder resin, kneading the mixture, crushing the kneaded mixture, and classified according to size. Further, generally inorganic fine particles such as silica or titanium oxide, or inorganic fine metal powder is added externally in order to add fluidity to the toner, control charging of the toner, and improve capability of toner to be cleaned.

As a method of using magnetic toner, there is one which is called a magnetic single-component toner jumping type developing method, in which a developer carrying body having a developing sleeve (having a magnetic roller internally) is provided, toner is charged and formed into a thin layer on the developing sleeve by allowing toner to be retained on the sleeve and pass through a gap between the sleeve and a magnetic blade, and the electrostatic latent image formed on the latent image carrying body is developed by the charged toner on the sleeve. As dielectric magnetic toner is used in this magnetic single-component toner jumping type developing method, transfer of toner image on the surface of a recording medium such as a sheet of paper by utilizing an electric field is possible, which has been impossible when electrically conductive toner is used, and further the occurrence of breakage of latent image carrying body due to electrical leaks thereto can be prevented.

Further, because dielectric magnetic toner can be charged with ease, can be rubbed sufficiently with the developing sleeve while retaining the toner on the sleeve by magnetic force, and can be developed on the latent image without contacting the latent image, this method has an advantage that a background fogging phenomenon that the toner adheres to non-image zones or blanc space, with the result that a high-quality image can be formed.

In recent years, toner that can be fused by lower energy is required, and development work has been continued for toner using a resin of low softening point or wax of low melting point.

However, although the toner containing wax of low melting point is good in anti-offset property for it is superior in its releasing property from the heater roller, wax of low melting point is not compatible with binding resin and a large domain of wax of low melting point is formed in binding resin. As a result, when producing toner, toner is crushed in the domain and wax of low melting point becomes exposed on the surface of toner, and a filming phenomenon occurs on the surface of the photoreceptor. When toner particles are reduced in grain size in order to realize higher quality of image, the amount of wax on the surface of toner particles increases further and the problem is further aggravated.

As a method of solving a problem of occurrence of surface filming of the photoreceptor drum, toner externally added with magnetic powder is proposed in Japanese Laid-Open Patent Application No. 9-73186. However, there is a problem that when toner experiences thermal stress or stress due to use the external additive is buried in the toner particles resulting in decrease of fluidity of the toner and lack of a part of image occurs in the toner image obtained.

On the other hand, utilization of an a-Si photoreceptor of excellent durability is proposed as a photoreceptor to be used in combination with the magnetic toner mentioned above. In this case, a compact image forming system is established in combination with a blade type cleaning mechanism (see Japanese Patent 2713716).

With this method, cleaning performance can be improved and images of good quality can be stably formed repeatedly for many times without occurrence of fault in images due to insufficient cleaning. However, with the method disclosed in said Japanese Patent 2713716, it is intended to make organic fine particles to adhere to the magnetic toner (i.e. external addition) to allow the organic particles to work like spacers, but the organic particles and the toner stagnate at the extremity of the elastic blade, that is, at the part on the surface of the a-Si photoreceptor where the toner is pressed thereto. The organic fine particles are high in charging capacity, and when the stagnated particles are rubbed with the elastic blade and the a-Si photoreceptor for a long period, the amount of electrostatic charge of the toner becomes excessive, i.e. so-called charge-up is induced.

Accordingly, the amount of toner charged appropriately is reduced in developing process, and degradation of image such as reduction in image density, background fogging, irregularities in image, etc. is induced. Therefore, it may occur that clean images can not be obtained stably for a long period. The material of the cleaning blade at the cleaning part of the photoreceptor is not clear in the specification, however when an elastic blade of compact (usual) structure is used, it is highly likely that electrostatic charge that can not escape anywhere is accumulated on the toner and abnormal discharge (one point discharge) occurs on the photoreceptor inducing breakage of the charge generating layer and charge transporting layer of the surface of the photoreceptor and unrepairable defection occurs, as a result only faulty images are obtained.

As an a-Si photoreceptor is weak against dielectric breakdown by nature, dielectric breakdown such as mentioned above tends to occur. Therefore, when image forming by the jumping type developing phenomenon of magnetic single-component toner is repeated through using the a-Si photoreceptor, elastic blade, and magnetic toner, abnormal discharge could occurs as mentioned above resulting in dielectric breakdown of the a-Si photoreceptor. When image forming is continued using thus damaged a-Si photoreceptor, small black points appear in the image formed, for the carrier blocking layer is damaged at the portion dielectric property is damaged and the portion can not be charged.

In Japanese Laid-Open Patent Application No. 2003-149857 is proposed toner having free magnetic powder to prevent the occurrence of damage of the photoreceptor through preventing charge leaks by the free magnetic powder. However, it is feared that free magnetic powder adheres to the developing sleeve and also to the photoreceptor. It is well known that when adhesion of even minute amount of magnetic powder occurs, it nucleates the growth of adhesion and induces a crucial defect in the image.

Further, to add magnetic powder of octahedral grain shape externally is proposed in Japanese Laid-Open Patent Application No. 2003-66647. Currently, magnetic powder of spherical grain shape as shown in FIG. 3(a), of hexahedral grain shape that is a convex polyhedron surrounded with six quadrangles(cube, cuboid) as shown in FIG. 3(b), of octahedral grain shape that is a convex polyhedron surrounded with eight triangles as shown in FIG. 3(d) are used generally.

Among these, when magnetic powder of polyhedral grain shape which have edges such as an octahedron or hexahedron (FIG. 3(d), FIG. 3(b), for example) is externally added, the powder grains on the surface of toner can effectively grind the surface of the photoreceptor and maintain the surface always clean without stains. Therefore, the problem of filming can be effectively solved, however, on the contrary, charge leaks tend to occur more than necessary from the pointed apexes and sharp ridges between adjacent surfaces of the magnetic powder grain.

Therefore, with magnetic toner added externally with magnetic powder of polyhedral grain shape, there is a problem that prompt rise in the amount of charge is difficult and the charge amount itself is low, as a result reduction in image density and background fogging tend to occur. Further, as easiness to be charged and the amount of charge changes depending on the environment temperature, humidity when forming images, defects in images tends to occur further easily particularly under high temperature and high humidity conditions under which easiness to be charged is reduced. Further, as the edges of the magnetic powder art too sharp, scratches occur on the surface of the photoreceptor.

On the contrary, in the case of toner externally added with magnetic powder of spherical grain shape as shown in FIG. 3(a), the magnetic powder grain has no pointed apex and therefore, it is not easy to be discharged, so charge leaks are not easy to occur. However, on the contrary, electrostatic charge accumulates excessively on the toner externally added with magnetic powder of spherical grain shape, and so-called charge-up tends to occur that the toner is charged more than necessary, for example, when the toner experiences repetition of friction in the gap between the developer retaining member and magnetic blade. Therefore, there is a problem that when the charge-up occurs, reduction in image density which is a representative image defection tends to occur. Further, imperfect formation of thin layer of toner on the developing sleeve, so-called irregular toner layer, occurs. Furthermore, also black points occur due to a charge leak phenomenon to the photoreceptor. There is an advantage in the case of the spherical magnetic powder grain that scratches are not created on the surface of the photoreceptor, however, filming preventing effect can not be expected because of insufficient ability of grinding the surface of the photoreceptor.

The amount of charge of toner has a large influence on dielectric breakdown in the photoreceptor. If the toner is excessively charged at the blade part, discharge occurs to the photoreceptor, and the photoreceptor experiences dielectric breakdown as mentioned before. Therefore, it is required to control the charge amount of toner properly, however, the charge amount of magnetic single-component toner varies largely also by the magnetic powder internally added thereto.

In the case of magnetic toner externally added with magnetic powder of polyhedral grain shape such as an octahedron or hexahedron as shown in FIG. 3(d) or FIG. 3(b) for example, electrostatic charge is easily discharged from the pointed apexes and sharp ridged formed by adjacent surfaces of the magnetic powder grain as mentioned above revealing on the surfaces of the toner particles, so even if the magnetic toner stagnates at the edge part of the elastic blade and experiences friction for a long period, the toner is prevented from excessive charging by the discharge via the apexes and ridges before the amount of accumulated electrostatic charge reaches the amount that induces dielectric breakdown of the a-Si photosensitive layer. Therefore, dielectric breakdown of the a-Si photosensitive layer does not occur easily.

However, on the contrary, since electrostatic charge tends to be discharged easily from the pointed apexes and sharp ridges of the magnetic powder grains, excessive discharge tends to occur more than necessary further the polyhedral magnetic powder grain is low in fluidity and dispersibility in binder resin, it is difficult to allow the magnetic powder to disperse evenly in the binder resin. Accordingly, dispersed condition of the magnetic powder in each of toner particles tends to vary, so easiness to be charged and the amount of charge of each particle of the magnetic toner tend to vary, as a result the toner externally added with magnetic powder of polyhedral grain shape is inferior in prompt charge rise property and in addition the amount of charge is reduced.

On the other hand, in the case of magnetic toner externally added with magnetic powder of spherical grain shape, charge leaks do not occur easily, the magnetic powder is superior in fluidity and dispersibility compared to the case polyhedral magnetic powder is added, so it is easier to allow even dispersion in binder resin, as a result variation in dispersion of the magnetic powder does not occur in each toner particle and easiness to be charged and the amount of charge of the toner can be made even. However, as excess charge tends to accumulate and charge-up of toner tends to occur. When the amount of charge exceeds the withstand pressure of the a-Si photoreceptor, the photoreceptor is damaged and black points appear in imaged formed after the damage.

When considering only to prevent the charge-up, it is preferable to use magnetic powder of polyhedral grain shape, however, electrostatic charge is easily discharged from the pointed apexes and sharp ridges of the magnetic powder grains revealing on the surfaces of toner particles as mentioned above, and charge leaks tend to occur. Further, magnetic powder of polyhedral grain shape is low in fluidity and dispersibility in the binder resin, and it is difficult secure even distribution of the magnetic powder in the binder resin. Accordingly, variation tends to occur in distribution of magnetic powder in each particle of toner and also variation of easiness to be charged and the amount of charge occurs in each particle of the magnetic toner.

To take advantage of both spherical magnetic powder and polyhedral magnetic powder, magnetic powder of which the grain shape is such that the apexes and ridges of a polyhedron such as an hexahedron or octahedron are chamfered to form faces smaller than the faces of the polyhedron is disclosed, for example, in Japanese Laid-Open Patent Application No. 11-153882, No. 2000-162817, No. 2000-242029.

However, there remain on the magnetic powder grain of said conventional art still sharp ridges formed at the intersections of the faces of the original polyhedron and small faces formed by chamfering, and electrostatic charge tends to leak from the sharp ridges. Therefore, said magnetic powder provided by the conventional art has basically a tendency the same as that of magnetic powder of polyhedral grain shape. Therefore, when magnetic powder of the conventional art is used, there remain fears that charge leaks occur and image defection such as reduction in image density is induced.

In Japanese Laid-Open Patent Application No. 2003-280254 is proposed toner which contains two kinds of external additives different in specific resistance, of which the disengagement rate of the one smaller in specific resistance is larger than that of the other one larger in specific resistance, the amount of electrostatic charge of toner being able to be adjusted by the one smaller in specific resistance. However, the evaluation testof this tonerwasperformedonlyfor 1000 sheets of printing, as to longevity demanded at present time it is not yet confirmed, and it is supposed that a variety of problems may occur when the evaluation test is continued for a larger number of sheets of printing.

Further, when inorganic metal oxide of high volume resistivity is used as an external additive, there is a difficulty in forming a thin toner layer on the developing sleeve in the case of a jumping type developing method using magnetic single-component toner, defective formation of thin layer of toner is induced particularly in an environment electrostatic charge is easy to increase under low temperature and low humidity, and sufficiently high resolution, high image quality can not be attained initially and for a long period.

Further, as inorganic metal oxide used as an external additive generally exerts no magnetic force, the additive exfoliates from toner particles when agitated in the developing device for a long period, and the toner can not perform its primary function, resulting in problems in durability.

As has been mentioned in the forgoing, there are problems concerning magnetic powder of convex polyhedral grain shape such as an hexahedron (cube, cuboid) surrounded with six quadrangles or octahedron surrounded eight triangles which is said generally high in grinding effect that reduction in image density is induced due to deficient charge amount when the magnetic powder is added externally the same as when internally added, for the amount of electrostatic charge of toner is reduced owing to the effect of the shape of the magnetic powder grain. Further, there is a problem that, although magnetic powder of grain shape of octahedron or cube is high in grinding effect owing to its pointed apexes, they will scratch the surface of the photoreceptor drum in repetition of image forming for a long period.

### SUMMARY OF THE INVENTION

Therefore, the present invention aims to provide magnetic single-component toner of which externally added magnetic powder is not buried into the toner even when the toner has experienced stress due to use and thermal stress, which is superior in stability of electrostatic charge and allow images without lack in parts of the image to be formed stably, and with which occurrence of a filming phenomenon of the photoreceptor drum and dielectric breakdown due to charge leaks to the photoreceptor drum are prevented and stable formation of thin layer of toner on the developing sleeve for a long period of use can be secured, and a developing unit and image forming apparatus using the toner.

To attain the object, inventors of the present invention have carried out keen examination, and has eventually come to use magnetic powder as an external additive of magnetic single-component toner and to use magnetic powder of basically polyhedral grain shape with apexes and ridges rounded as to comply with highly durable system.

It became evident that, in an image forming apparatus comprising a latent image carrying body having an amorphous silicon photoreceptor, a toner having a magnetic roller inside thereof and disposed to face said latent image carrying body without contacting therewith and rotating with magnetic single-component toner retaining on the surface thereof, a means for allowing a toner image to be formed on the surface of said latent image carrying body by allowing said magnetic single-component toner to jump toward said latent image, and a cleaning means using an elastic blade pressed against the surface of the latent image carrying body for cleaning the toner remaining on the surface after the toner image is transferred onto a recording medium, by composing magnetic single-component toner such that the binder resin composing the toner contains at least magnetic powder and externally adding magnetic powder of polyhedral grain shape with apexes and ridges being rounded to be formed into curved surfaces such that portions deemed as straight lines remain on the circumference of the projected figure of the grain and either volume specific resistance of the externally added magnetic powder is in a range of 10²-10⁹ Ωcm or disengagement rate of the externally added magnetic is 10-25% or both conditions are sufficed, discharge occurs from disengaged magnetic powder before the charge potential reaches the potential that causes dielectric breakdown of the a-Si photoreceptor even if the toner still remaining on the surface of the photoreceptor after the toner image is transferred onto the recording medium and cleaning of the surface of the photoreceptor is performed accumulate at the extremity of the cleaning blade, and the accumulated toner tends to be charged-up by the friction at the extremity of the cleaning blade, therefore, occurrence of defective image due to dielectric breakdown of the photoreceptor can be prevented even if an a-Si photoreceptor of film thickness of equal to or thinner than 30 μm is used.

In addition, by using the toner of the invention, even when warming up period is short under high temperature high humidity environment, stable formation of thin layer of toner can be secured and reduction in image density can be prevented.

It is thought that, as the magnetic powder of grain shape as mentioned above has rounded apexes and ridges and has not pointed apexes and sharp ridges from which discharge tends to occur, excessive discharge does not tend to occur when such magnetic powder is externally added to toner particles. Furthermore, the magnetic powder grain is basically octahedral, so either of the intersection angle of adjacent surfaces straddling an apex or ridge or either of the intersection angle of adjacent surfaces straddling an apex is necessarily an acute angle smaller than 90°, and electric charge tends to concentrate to the apexes the surfaces or ridges intersect and ridges where the surfaces intersect. Therefore, it is thought that excessive charge is prevented by rounding the apexes and ridges to allow electric charge to be discharged in proper proportion from the rounded apexes and ridges where electric charge tends to concentrate.

By using magnetic powder as an external additive, the external additive tends to be adhered to toner by the magnetic force. When inorganic metal oxide such as titanium oxide, zinc oxide, magnesium oxide, silicon carbide, etc. that can not exert magnetic force is used as an external additive as has been conventionally, the external additive peels off from toner particles when the toner is agitated in the developing device for a long period, and the primary function of toner is lost.

By using magnetic powder as an external additive, the external additive adheres firmly to toner particles, so it does not pees of from toner particles when agitated in the developing device for a long period and the toner can maintain primary function for a long period.

However, even when magnetic powder is of grain shape mentioned above, if curvature radiuses of the rounded apexes and ridges are too large, the effect of preventing charge-up of the magnetic toner by allowing electric charge to be properly discharge can not be obtained. Therefore, the inventors considered to define a limit range of the curvature radiuses to round the apexes and ridges.

As a result, it was found that, although effect of preventing charge-up of the magnetic toner could not be obtained with magnetic powder of grain shape of which curvature radiuses of apexes and ridges are too large and adjacent curved surfaces of the apexes and ridges continue to each other resulting in a near sphere-like shape without portions deemed as straight lines on the circumference of the projected figure of the grain as could not with magnetic powder of spherical shape, however, in the case of magnetic powder of octahedral grain shape with apexes and ridges being rounded to be formed into curved surfaces such that portions deemed as straight lines remain on the circumference of the projected figure of the grain, although apexes and ridges where adjacent surfaces intersect are formed into curved surfaces, curvature radiuses of the curved surfaces are small compared with those of near sphere-like magnetic powder grain, so electric charge can be discharged in a proper proportion from rounded apexes and ridges where electric charge tends to concentrate, as a result, when this magnetic powder is added externally to magnetic toner, excessive charge leak is prevented and at the same time excessive charge of toner can be prevented compared to the case magnetic powder of grain shape of which apexes and ridges are not rounded is used.

Although apexes and ridges of the magnetic powder grain are rounded, portion deemed as straight lines remain on the circumference of the projected figure of the grain, so the photoreceptor is ground by the straight line parts and occurrence of a drum filming phenomenon can be prevented. Therefore, magnetic single-component toner can be obtained with which embedment of external additives into the surfaces of toner particles does not occur when experiencing stress due to use and thermal stress for a long period, stability of toner is excellent and stable images without lacked parts in the image can be obtained, further dielectric breakdown due to charge leak to the photoreceptor drum can be prevented, and long-lasting stability of formation of thin layer of toner on the developing sleeve.

In addition, it was found that not only the grain shape of the externally added magnetic powder is important but disengagement rate is also important and disengagement rate of the externally added magnetic powder should be in a range of 10-25%.

When the disengagement rate is smaller than 10%, electric charge of toner can not be discharged effectively due to too small amount of disengaged magnetic powder even if magnetic powder of grain shape as mentioned above is used. On the contrary, When the disengagement rate is larger than 25%, although electric charge of toner can be reduced largely and dielectric breakdown can be prevented, reduction in image density is induced, and in addition, disengaged magnetic powder adheres to the surface of the developing sleeve and defective formation of thin layer of toner on the surface of the developing sleeve resulting in crucial defect of image formation.

In the present invention, there is not particular restriction concerning binder resin, magnetic material, dyestuff, pigment, charge control agents, etc., and volume specific resistance of magnetic powder for external addition is not only to be in a range of 10²-10⁹ Ωcm, but also preferable to be 10³-10⁸ Ωcm, more preferable to be 10⁴-10⁸ Ωcm, and average grain size is also not only to be 0.01-0.50 μm, but also preferable to be 0.005-0.35 μm.

Therefore, magnetic toner of the present invention is magnetic single-component toner of which binder resin composing the toner contains at least magnetic powder is externally added on its surface with magnetic powder and which toner is retained on a developing sleeve surface for developing a latent image formed on a latent image carrying body by a magnetic toner jumping type developing method, said developing sleeve having a magnetic roller inside thereof and being disposed to face said latent image carrying body without contacting therewith, wherein said externally added magnetic powder is of polyhedral grain shape with apexes and ridges being rounded to be formed into curved surfaces such that portions deemed as straight lines remain on the circumference of the projected figure of the grain and has volume specific resistance of in a range of 10²-10⁹ Ωcm.

The externally added magnetic powder is of convex octahedral grain shape surrounded with 8 triangles with apexes and ridges being rounded to be formed into curved surfaces such that portions deemed as straight lines remain on the circumference of the projected figure of the grain.

Further, the toner of the invention is magnetic single-component toner of which binder resin composing the toner contains at least magnetic powder is externally added on its surface with magnetic powder for developing a latent image formed by an electrographic process on an amorphous silicon photoreceptor onto the surface against which an elastic blade is pressed for cleaning the toner remaining on the surface, wherein said externally added magnetic powder is basically of convex octahedral grain shape surrounded with 8 triangles with apexes and ridges being rounded to be formed into curved surfaces such that portions deemed as straight lines remain on the circumference of the projected figure of the grain and disengagement rate of said externally added magnetic powder is 10-25%.

It is preferable that said magnetic powder contained in said binder resin is of spherical grain shape, said externally added magnetic powder is of average grain size of 0.01-0.50 μm, and said externally added magnetic powder is added by 0.1-5.0% by weight.

The developing unit to use the magnetic single-component toner has a developing sleeve for carrying magnetic single-component toner of which binder resin composing the toner contains at least magnetic powder is externally added on its surface with magnetic powder of octahedral grain shape with apexes and ridges being rounded to be formed into curved surfaces such that portions deemed as straight lines remain on the circumference of the projected figure of the grain and has volume specific resistance of in a range of 10²-10⁹ Ωcm, said developing sleeve having a magnetic roller inside thereof and being disposed to face a latent image carrying body on which a latent image is formed without contacting therewith and being finished to have 10 points average surface roughness equal to or larger than 2 μm and smaller than 6.0 μm, whereby said latent image formed by an electrographic process on said latent image carrying body is developed by magnetic toner jumping type developing method.

The image forming apparatus to use the magnetic single-component toner comprises a latent image carrying body having an amorphous silicon photoreceptor, a toner having a magnetic roller inside thereof and disposed to face said latent image carrying body without contacting therewith and rotating with magnetic single-component toner retaining on the surface thereof, a means for allowing a toner image to be formed on the surface of said latent image carrying body by allowing said magnetic single-component toner to jump toward said latent image, and a cleaning means using an elastic blade pressed against the surface of the latent image carrying body for cleaning the toner remaining on the surface after the toner image is transferred onto a recording medium, wherein said magnetic single-component toner of which binder resin composing the toner contains at least magnetic powder is externally added on its surface with magnetic powder of basically polyhedral shape with apexes and ridges being rounded to be formed into curved surfaces such that portions deemed as straight lines remain on the circumference of the projected figure of the grain so that disengagement rate of said magnetic powder is 10-25%.

Said magnetic toner added externally to said magnetic single-component toner is of volume specific resistance of in a range of 10²-10⁹ Ωcm, and a developing sleeve of said toner carrying body is finished to have 10 points average surface roughness (Rz) equal to or larger than 2 μm and smaller than 6.0 μm.

Said latent image carrying body has an amorphous silicon photoreceptor of film thickness of 10-30 μm.

By composing magnetic single-component and a developing unit and image forming apparatus to use said toner as recited in the forgoing, it becomes possible to obtain toner of which externally added magnetic powder is not buried into the toner even when the toner has experienced stress due to use and thermal stress, to obtain stable images without lack in parts of the image owing to superior stability of electrostatic charge of the toner, to prevent occurrence of a filming phenomenon of the photoreceptor drum and dielectric breakdown due to charge leaks to the photoreceptor drum, and to secure stable formation of thin layer of toner on the developing sleeve for a long period.

### BRIEF DESCRIPTION OF THE DRAWINGS

FIG. 1 is a three-view drawing showing an example of magnetic powder grain of the present invention which is basically of a convex polyhedron surrounded with 8 triangles, i.e. an octahedron and its apexes and ridges are rounded, FIG. 3c is a plan view, FIG. 3a is a front view of a triangle part depicted with chain lines in FIG. 3(c), and FIG. 3(b) is a side view viewed from the direction of a ridge line depicted with a chain line in FIG. 3(c).

FIG. 2 is an electron micrograph showing an example of magnetic powder used in the magnetic toner of the present invention.

FIG. 3 is a schematic drawing showing examples of the grain shape of magnetic powder externally added to toner, FIG. 1a shows a spherical grain, FIG. 1b shows a hexahedral grain, FIG. 1d shows an octahedral grain, and FIG. 1e shows a rounded octahedral grain.

FIG. 4 is a schematic representation of the structure of the developing unit and image forming apparatus in which the magnetic toner of the present invention is used.

FIG. 5 is a section of the photoreceptor drum (latent image carrying body) used in the image forming apparatus of the invention.

FIG. 6 is a graph showing a relation between film thickness of the amorphous silicon photoreceptor and needle withstand voltage of dielectric breakdown.

FIG. 7 is a table showing test results under normal temperature normal humidity environment using magnetic toner of the first embodiment of the present invention and toner of comparative examples 1 to 6.

FIG. 8 is a table showing test results under high temperature and high humidity environment using magnetic toner of the first embodiment of the present invention and toner of comparative examples 1 to 6.

FIG. 9 is a table showing test results under low temperature and low humidity environment using magnetic toner of the first embodiment of the present invention and toner of comparative examples 1 to 6.

FIG. 10 is a table showing test results under normal temperature normal humidity environment using magnetic toner of the first to fifth embodiments of the present invention and toner of comparative examples 7 and 8.

FIG. 11 is a table showing test results under high temperature and high humidity environment using magnetic toner of the first to fifth embodiments of the present invention and toner of comparative examples 7 and 8.

FIG. 12 is a table showing test results under low temperature and low humidity environment using magnetic toner of the first to fifth embodiments of the present invention and toner of comparative examples 7 and 8.

FIG. 13 is a table showing test results under normal temperature normal humidity environment using magnetic toner of the first and sixth to ninth embodiments of the present invention and toner of comparative examples 9 and 10.

FIG. 14 is a table showing test results under normal temperature normal humidity environment using magnetic toner of the first and eighth embodiments of the present invention and toner of comparative examples 11 to 14.

FIG. 15 is a table showing test results under normal temperature normal humidity environment magnetic using toner of the tenth embodiment of the present invention and toner of comparative examples 15 to 20.

FIG. 16 is a table showing test results under high temperature and high humidity environment using magnetic toner of the tenth embodiment of the present invention and toner of comparative examples 15 to 20.

FIG. 17 is a table showing test results under low temperature and low humidity environment using magnetic toner of the tenth embodiment of the present invention and toner of comparative examples 15 to 20.

FIG. 18 is a table showing test results under normal temperature normal humidity environment using magnetic toner of the tenth to fourteenth embodiments of the present invention and toner of comparative examples 21 and 22.

FIG. 19 is a table showing test results under high temperature and high humidity environment using magnetic toner of the tenth to fourteenth embodiments of the present invention and toner of comparative examples 21 and 22.

FIG. 20 is a table showing test results under low temperature and low humidity environment using magnetic toner of the tenth to fourteenth embodiments of the present invention and toner of comparative examples 21 and 22.

FIG. 21 is a table showing test results under normal temperature normal humidity environment using magnetic toner of the tenth and fifteenth to eighteenth embodiments of the present invention and toner of comparative examples 23 and 24.

FIG. 22 is a table showing test results under normal temperature normal humidity environment using magnetic toner of the tenth and seventeenth embodiments of the present invention and toner of comparative examples 25 to 28.

FIG. 23 is a table showing results of tests for evaluating the condition of thin layer of toner, initial image density, and black points due to charge leaks when Rz (10 points average roughness) of the surface of the developing sleeve is changed under normal temperature normal humidity using magnetic toner of the tenth embodiment of the present invention.

FIG. 24 is a table showing the grain shape of magnetic powder used for evaluation tests of toner of the present invention and disengagement rate of magnetic powder added externally to toner.

FIG. 25 is a table showing test results under normal temperature normal humidity using toner of embodiments of the present invention and toner of comparative examples.

FIG. 26 is a table showing test results under high temperature and high humidity using toner of embodiments of the present invention and toner of comparative examples.

### DETAILED DESCRIPTION OF THE PREFERRED EMBODIMENTS

Preferred embodiments of the present invention will now be detailed with reference to the accompanying drawings. It is intended, however, that unless particularly specified, dimensions, materials, relative positions and so forth of the constituent parts in the embodiments shall be interpreted as illustrative only not as limitative of the scope of the present invention.

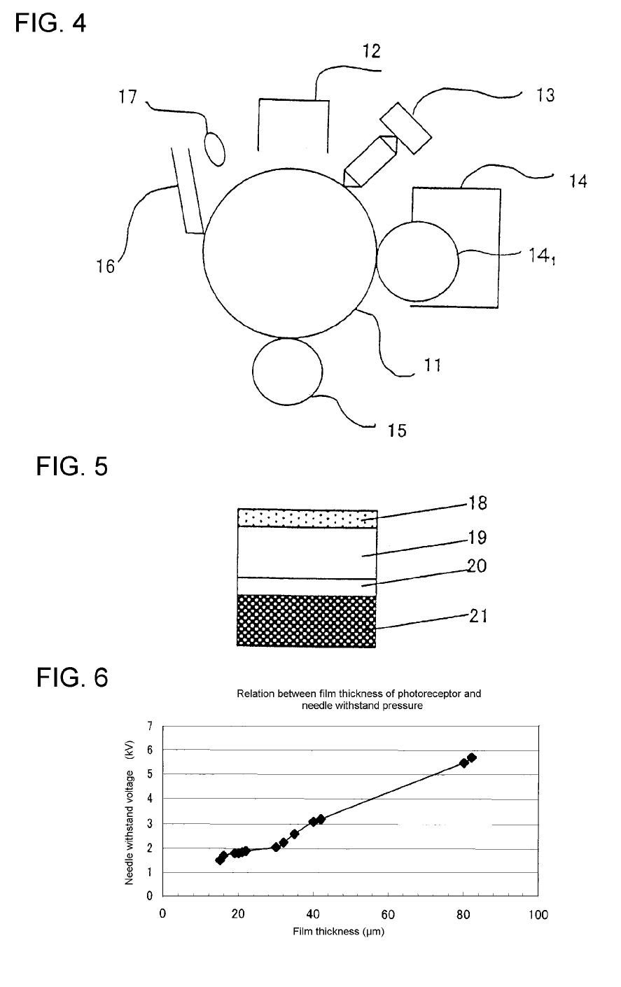

FIG. 4 is a schematic representation of the structure of the developing unit and image forming apparatus in which the magnetic toner of the present invention is used, FIG. 5 is a section of the photoreceptor drum (latent image carrying body) 11 used in the image forming apparatus of the invention, and FIG. 6 is a graph showing a relation between film thickness of the amorphous silicon photoreceptor and needle withstand voltage of dielectric breakdown. First, the structure of the image forming apparatus in which magnetic single-component toner according to the present invention is used will be explained schematically referring to FIG. 4, FIG. 5, and FIG. 6.

Referring to FIG. 4, photoreceptor drum (latent image carrying body) 11 is composed of a drum of diameter of 30 mm having a photosensitive layer of to be positively charged amorphous silicon (hereafter referred to a-Si). Around the photoreceptor drum 11 are disposed an electrostatic charging device 12 applying a scorotron for example, an exposing device 13, a developing device 14 having a toner carrying body 14₁ which is comprised of a rotatably supported developing sleeve with toner retained on its surface and having a magnet fixed inside thereof and facing the latent image carrying body with a gap kept thereto so as not contact the latent image carrying body, a transfer roll 15 for transferring images, a cleaning blade 16 made of elastic material such as rubber for cleaning the surface of the photoreceptor drum 11, and a discharging lamp 17 for discharging the surface of the photoreceptor drum 11. A recording medium such as a sheet of paper or OHP film not shown in the drawing is passed between the photoreceptor drum 11 and transfer roll 15, and a fusing device is disposed downstream from the drum 11 and roll 15 on a discharge route of the recording medium.

(Construction of Electrostatic Charging Device)

The electrostatic charging device 12 used in the image forming apparatus of the present invention is a scorotron charger 12 for example. This is composed of a shield case, a corona wire, and a grid, charge width is 12.0 mm in circumferential direction and 242 mm in axial direction of the drum. The distance between the wire and the grid is preferably determined to be 5.8 mm. The distance between the grid and the a-Si photoreceptor surface is preferably determined to be 0.4-0.8 mm, there is a possibility of occurring spark discharge when said distance is smaller than 0.4 mm and charging ability reduces when said distance is larger than 0.8 mm.

(Construction of a-Si Photoreceptor)

As the a-Si photoreceptor is used a photoreceptor constructed such that, as shown in FIG. 5, a carrier blocking layer 20 and a photosensitive layer 19 composed of single or two layers of a-Si group are formed on the surface of a support 21 made of electrically conductive material such as aluminum, etc. and formed into a desired shape such as drum shape, etc. It is suitable to provide a surface protective layer 18, etc. It is preferable to construct the photoreceptor as a thin film type a-Si photoreceptor with total thickness of the layers of 10-30 μm. The thin film type a-Si photoreceptor like this is excellent in productivity as mentioned before and has in addition an advantage that it can form images of high resolution.

(Film Thickness of a-Si Photoreceptor)

In the embodiments, the film thickness of the a-Si photoreceptor means the thickness from the surface of the support 21 to the surface of the photoreceptor, that is, the sum of the carrier blocking layer 20, photosensitive layer 19, and surface protective layer 18. The reason that the film thickness, the sum of the carrier blocking layer 20, photosensitive layer 19, and surface protective layer 18 formed on the surface of the electrically conductive support 21 is determined to be in a range of 10-30 μm is that, when the film thickness is thinner than 10 μm, charging capacity of the photoreceptor reduces and it is difficult to obtain prescribed surface potential, and that due to irregular reflection of laser light on the surface of the electrically conductive support 21 interference fringes appear in a halftone pattern.

On the other hand, when the film thickness of the a-Si photoreceptor is thicker than 30 μm, moving speed of hot carrier increase and dark decay characteristic is degraded, as a result latent image flow toward the surface of the photoreceptor tend to occur, which causes reduction in resolution. It is well known that the thinner the film thickness of photoreceptor is, the more the resolution is improved, not only in an a-Si photoreceptor but in an OPC photoreceptor. The thicker the film thickness is, the longer the time necessary for forming the film is, andpossibility of adhering of foreign matter increases with increased film forming time resulting in decreased process yield. Therefore, the thinner the film thickness of the photoreceptor is, the lower the cost is and the more stable the image quality is.

Therefore, it is preferable that the total film thickness of the photoreceptor is 10-30 μm from viewpoints of charging capacity, pressure tightness, dark decay characteristic, production cost, and image quality. It is more preferable that the thickness of the surface protective layer is thinner than 20000 angstrom, further in a range of 5000-15000 angstrom.

This is because when the thickness of the surface protective layer is thinner than 5000 angstrom, characteristic of pressure tightness is degraded against flowing in of negative current from the transfer roll, as a result the Si layer is deteriorated in an early stage of image formation of 15000 sheets or lesser, on the contrary, the thickness of the surface protective layer exceeds 20000 angstrom, longer time is needed for forming the layer resulting in increased cost. Therefore, the thickness of the surface protective layer is more preferable to be between 5000-15000 angstrom from viewpoints of balance of charging capacity, wear resistance, environ resistance, and time needed for forming the layer.

On the other hand, the occurrence of black point due to charge leaks to the a-Si photoreceptor depends largely on needle pressure tightness (voltage) of the a-Si photoreceptor. As shown in FIG. 6, Voltage needed to induce dielectric breakdown increases with increase of the film thickness of the amorphous silicon photoreceptor. So, the thinner the film thickness is, the voltage to induce dielectric breakdown decreases. Therefore, when using an a-Si photoreceptor of small film thickness equal to or smaller than 30 μm, charge leaks to the photoreceptor increases significantly with slight charge-up. In FOG. 6, abscissa represents the total film thickness of the a-Si photoreceptor, and ordinate represents needle pressure tightness to induce discharge breakdown.

(Material of Photoreceptor)

The photosensitive layer 19 of the a-Si photoreceptor can be formed, for example, by the glow discharge decomposition method, spattering method, ECR method, vapor growth method such as evaporation method. When forming the layer, H and halogen elements are allowed to be contained in the layer. Further, it is permitted to allow elements such as C, N, O, or 13^{th} group elements, or 15^{th} group elements in the periodic table (long period type) to be contained in the layer for adjusting characteristic of the photoreceptor.

Concretively, the photosensitive layer 19 can be formed with a variety of material of a-Si group having photoconductivity such as, for example, a-SiC, a-SiO, a-SiON, etc. in addition to a-Si. Particularly, it is preferable to use a-SiC, and in this case, it is preferable to determine value x in Si₁₋ₓCₓ to be 0.3□x<1.0, further preferably 0.5□x<0.95. With this range of x value, a-SiC layer can be made higher in resistance than a-Si while maintaining good transport property of carrier, and photosensitivity characteristic of the photoreceptor can be increased. As elements belonging to 13^{th} and 15^{th}, B and P are preferable from viewpoints that with them the characteristic of semiconductor can be changed sensitively and superior photosensitivity can be obtained.

The reason is that a-SiC has high resistance of 10¹²-10¹³ Ωcm, flow of the charge of latent image toward the surface of the photoreceptor is small, and also superior in sustaining ability of the latent image and moisture resistance.

(Characteristic to be Discriminated of OPC and Amorphous Silicon)

Generally, surface resistance of OPC photoreceptor is in the order of 10¹³ Ωcm and this is extremely high compared to that of a-Si photoreceptor which is in the order of 10⁸ Ωcm. Therefore, dielectric breakdown does not occur easily in OPC photoreceptor. Accordingly, there is less fear of occurrence of black points in the case of OPC photoreceptor.

(Surface Potential of Photoreceptor)

Electric potential on the surface of the a-Si photoreceptor is not particularly limitted, however, it is preferable to be in a range of +200-+500 V. When surface potential of the photoreceptor is lower than +200 V, electric field for developing is insufficient and it is difficult to secure image density. On the other hand, when surface potential exceeds +500 V, there occur problems that charging capacity of the photoreceptor becomes deficient depending on film thickness, black points tend to occur due to dielectric breakdown, and generation of ozone increases. Particularly, when the film thickness is thin, charging capacity of the photoreceptor tends to decrease in accordance with decrease in thickness of the film. Therefore, it is preferable that the value of surface potential is in a range of +200 V to +500 V in viewpoints of balancing development performance and charging capacity of the photoreceptor, further preferably it is in a range of +200V to +300 V.

(Developing Device)

Referring again to FIG. 4, the developing device 14 to treat toner of the present invention is provided with the toner carrying body 14₁ which is composed of the developing sleeve having a magnetic roller fixed inside thereof and located to face the photoreceptor 11, a thin toner layer is carried on the surface of the toner carrying body 14₁, voltage supplied from an AC or DC electric source is applied for allowing the toner on the developing sleeve to fly to the photoreceptor, and the electrostatic latent image formed on the photoreceptor is developed to a visible tone image by the magnetic single-component toner jumping type developing method.

The surface of the developing sleeve is rough, toner is carried on this surface as the sleeve rotates, and a thin toner layer is formed on the surface by allowing the toner carried on the surface of the developing sleeve to pass through a gap between a magnetic blade not shown in the drawing and the developing sleeve. Surface roughness of the surface of the sleeve is such that 10 points average roughness Rz is 2.0 μm or larger and smaller than 6.0 μm. When 10 points roughness Rz is smaller than 2.0 μm, sufficient image density can not be obtained due to reduced toner carrying ability. When Rz exceeds 6.0 μm, image quality is degraded, and leaks occur from raised portions on the sleeve surface to the photoreceptor drum, which causes occurrence of black points in the image and image quality is damaged. 10 points average roughness can be measured by a surface roughness meter, surfcoder SE-30D of Komatsu Research Institute, Ltd.

As material of the developing sleeve, aluminum, SUS, etc. can be used. When considering high durability, it is preferable to use SUS, for example, SUS303, SUS304, SUS305, SUS316, etc. It is more preferable to use SUS305 which is weak in magnetism and easy to be worked.

(Transfer Roll)

To allow a latent image to be retained on the surface of the a-Si photoreceptor drum 11, the surface is charged uniformly by the charging device 12 such as a scorotron charger, then the surface is exposed by exposing device 13 using semiconductor laser, light-emitting diode, etc. to remove electric charge of exposed portions. This process is the same to the conventional process. To transfer the toner image formed on the surface of the a-Si photoreceptor drum 11 to a recording medium surface, a corona charger, serrated electric pole, transfer roll, etc. is used, for example, and particularly a transfer roll 15 is preferable.

The transfer roll 15 is allowed to contact to the surface of the a-Si photoreceptor and rotated with circumferential speed difference of preferably 3-5% between thecircumferential speed of the transfer roll 15 and photoreceptor 11. When the circumferential speed difference is smaller than 3%, transfer performance of tone is decreased and lack of a part of image is feared to occur in the toner image obtained, when the difference exceeds 5%, slip at the contacting part increase and blurring of the transferred image, so-called jitter is feared to increase. Soft foam material such as foamed EPDM, for example, is preferably used as material of the transfer roll 15. When a roll made of foam is used, toner adhered to the transfer roll intrudes into pores of the foam material when jamming of the recording medium occurs, and back face staining of the recording medium at recommencement of operation can be prevented. Therefore, cleaning of the transfer roll becomes unnecessary, and initial cost and running cost can be reduced. Hardness of the soft foam material is preferable to be 30-40° by Ascar C hardness. When the hardness is lower than this range, occurrence of transfer fault is feared, and when harder than this range, it is feared that the nipping of the recording medium between the transfer roll and photoreceptor decreases and force to transport the recording medium decreases.

(Cleaning Device)

Toner remains on the surface of the a-Si photoreceptor drum 11 after the toner formed on the surface is transferred to a recording medium such as a paper sheet. As a cleaning means 16 to remove the remaining toner, an elastic blade pressed to the surface of the a-Si photoreceptor drum is preferable. A variety of well known elastic blade made of rubber or soft resin can be adopted as the elastic blade. In more particular, an elastic blade made of, for example, silicone rubber, fluorocarbon rubber, urethane rubber, and urethane resin can be used. The pressure to press the elastic blade is preferable to be 10-50 g/cm so that impression due to pressing is not created on the surface of the a-Si photoreceptor drum.

The operation of the image forming apparatus of the present invention will be explained briefly hereunder. The image forming apparatus is, for example, a printer of printing speed of 33 sheets per minute of A4 size paper (circumferential speed of 210 mm/s). A positive charging type a-Si photoreceptor drum 11 of diameter of 30 mm is used as a latent image carrying body. The a-Si photoreceptor drum 11 and the toner carrying body (developing sleeve) 14₁ which has a magnet fixed inside thereof and on the surface of which a thin layer of magnetic toner is formed rotate facing one another with a gap so that the thin layer of magnetic toner on the surface of the toner carrying body 14₁ does not contact the surface of the a-Si photoreceptor drum 11. After the photosensitive layer 19 of the photoreceptor 11 is charged evenly by the charging device 12, reflection of the light irradiated from the exposing device 13 and reflected from an original or dot light generated based on electric signals to correspond with the original is irradiated to the surface of the photoreceptor drum, and electric potential of the parts irradiated with the light is optically attenuated to form a latent image.

The electrostatic latent image is developed by applying voltage between the developing sleeve and the photoreceptor by means of the AC or DC electric source not shown in drawing and allowing the toner of the thin layer of toner carried on the surface of the developing sleeve to fly toward the photoreceptor drum 11, i.e. by the magnetic the single-component toner jumping method, a toner image is formed on the surface of the photoreceptor drum 11. The toner image is transferred onto the recording medium by means of the transfer roll 15, then the recording medium is conveyed to a fusing device not shown in the drawing to be fixed on the recording medium by heat and pressure. Toner remaining on the surface of the photoreceptor 11 after the toner image is transferred onto the recording medium is scraped off by the cleaning blade 16 of a cleaning device to be recovered, and surface charge is removed by exposing the surface to light by means of the discharging lamp 17.

(Binder Resin)

The toner of the invention is obtained by dispersing a variety of compounding agents such as dyestuff, etc. in a binder resin and internally adding magnetic powder, and then externally adding magnetic powder. The kind of the binder resin used for the toner of the invention is not particularly restricted, however, as resin to be used are cited, for example, polystyrene group resin, acryl group resin, polyethylene group resin, polypropylene group resin, polyvinyl chloride group resin, polyester group resin, polyamide group resin, polyurethane group resin, polyvinyl alcohol group resin, vinylether group resin, N-vinyl group resin, styrene-butadiene group resin, among them polystyrene group resin and polyester group resin are preferably used.

To be more particular, as polystyrene type resin can be cited binary or ternary or multiple copolymer of styrene monomer and others in addition to copolymer of styrene monomer.

Of these, single kind can be used, and also combination of a plurality of kinds can be coplymerized with styrene monomer.

As a monomer for coplymerization can be cited, ethylene unsaturated mono-olefin group such as p-chlorstyrene, vinyl naphthalene, ethylene, propylene, butylene, isobutylene, etc.; vinyl halide such as vinyl chloride, vinyl bromide, vinyl fluoride, etc.; vinylester group such as vinyl acetate, vinyl propionate, vinyl benzoylate, vinyl acetate, etc.; (meta)acrylic ester such as methyl acrylate, ethyl acrylate, n-butyl acrylate, 2-chlorethyl acrylate, phenyl acrylate, α-methyl chloracrylate, methyl methacrylate, ethyl methacrylate, butyl methacrylate, etc.; derivatives of other acrylic acid such as acrylonitryl, methacrylonitryl, acrylamide, etc.; vinylester group such as vinylmethylether, vinylisobutyleter, etc.; vinylketone group such as vinyl methylketon, vinyl ethylketon, methylisopropenylketon, etc.; and N-vinyl compounds such as N-vinylpyrrole, N-vinylcarbazole, N-vinylindole, N-vinylpyrrolidone, etc. Single kind among these monomers can be used, and also combination of a plurality of monomers of these monomer can be coplymerized with styrene monomer.

As polyester type resin can be cited a variety of polyester type resin obtained by condensation polymerization or condensation copolymerization of alcohol component and carboxylic acid component. As components used when synthesizing polyester type resin can be cited for example, first for alcohol component of oxidation number of 2 or 3 or over, diol group such as ethylene glycol, diethylene glycol, triethylene glycol, 1, 2-propylene glycol, 1,3-propylene glycol, 1,4-butanediol, neopentyl glycol, 1,4-butenediol, 1,5-penthanediol, 1,6-hexanediol, 1,4-cyclohexanedimethanol, dipropylene glycole, polyethylene grycol, polypropylene glycole, polyteramethylene glycole, etc.; bisphenol group such as bisphenol A, hydrogenated bisphenol A,polyoxiethylenated bisphenol A, polyoxipropylenatedbisphenolA, etc.; and alcohol group of oxidation number of 3 or over such as sorbitol, 1,2,3,6-hexanetetrol, 1,4-sorbitan, pentaneerithritol, di pentaneerithritol, tri pentaneerithritol, 1,2,4-butanetriol, 1,2,5-pentanetriol, glycerol, doglycerol, 2-methylpropanetriol, 2-methyl-1,2,4-butanetriol, trimethylolethane, trimethylolpropane, 1,3,5-hydroximethylbenzen, etc.

As carboxylic acid component can be cited oxalic acid, maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, n-butylsuccinic acid, n-butenylsuccinic acid, isobutylsuccinic acid, isobutenylsuccinic acid, n-octylsuccinic acid, n-octenylsuccinic acid, n-dodecylsuccinic acid, n-dodecenylsuccinic acid, isododecylsuccunic acid, iso dodecenylsuccinic acid, etc.; and carboxylic acid of oxidation number 3 or over such as such as 1,2,4-benzentricarboxylic acid(trimellitic acid), 1,2,5-benzentricarboxylic acid, 2,5,7-naphtalenetricarboxylic acid, 1,2,4-naphtalenetricarboxylic acid, 1,2,4-buthanetricarboxylic acid, 1,2,5-hexanetricarboxylic acid, 1,3-dicarboxyl-2-methyl-methylenecarboxipropane, 1,2,4-cyclohexanetricarboxylic acid, teta(methylenecarboxyl)methane, 1,2,7,8-octanetetracaboxyl acid, pyromellitic acid, empole trimer acid etc.

Softening point of polyester group rein is preferable to be 80-150° C. in order to be able to fix images on recording mediums such as paper sheets by fusing means used widely in usual electrophograhic apparatuses. It is more preferable that the softening point is 90-140° C.

It is preferable that the binder resin has crosslinkage structure in a part thereof. By allowing crosslinkage structure to be formed in a part of the binder resin, preservation stability, configuration conservation, durability of magnetic toner can be improved. Formation of crosslinkage structure in a part the binding resin can be realized by adding a cross-linking additive or by mixing thermosetting resin.

As thermosetting resin can be cited, for example, one or combination of two or more of epoxy group resin such as phenol A type epoxy resin, hydrogenated bisphenol A type epoxy resin, novolack-type epoxy resin, or polyalkylene-ether-type epoxy resin, cyclic aliphatic epoxy resin, or cyanate resin.

Glass transition temperature Tg of binder resin is preferable to be 50-65° C., more preferably 50-60° C. When the glass transition temperature is under this range, fusion of toner grains tends to occur and preservation stability may be reduced. Furthermore, as the strength of resin is low, it adheres to the surface of the latent image retaining member and does not clear away therefrom easily, resulting toner adhesion thereto. On the contrary, when the glass transition temperature is above this range, fixing ability of the toner to the surface of the recording medium such as a sheet paper may deteriorate.

Glass transition temperature of binder resin can be determined from an endothermic curve obtained for example by a differential scanning calorimeter(DSC) by finding the changing point of specific heat. Specifically, for example, it can be determined by measuring using a differential scanning calorimeter DSC-6200 in such a way in that 10 mg of sample resin is received in an aluminum pan and an empty aluminum pan is prepared as a reference pan, and measurement is carried out under ordinary pressure and in a temperature range of 25 to 200° C. with warm-up rate of 10° C. per minute to obtain an endothermic curve of the sample resin. The temperature at the transition point on the endothermic curve is determined as the glass transition temperature of the binder resin.

The toner of the invention may be added, for example, with a variety of well known additives such as dyestuff, an electric charge control agent, wax, etc. Among them, as dyestuff can be cited pigment for adjusting color tone such as carbon black, etc., and dyestuff such as acid violet. Percentage of the coloring agent in the toner particle is preferable to be about 0.5-5% wt.

(Charge Control Agent)

A charge control agent is a component blended for improving the charge level and rate of charge rise of toner to obtain developer of excellent durability and stability. There are positive charging and negative charging type charge control agent, any one of them is compounded in accordance with charging property of magnetic toner.

As control agents of positive charging property can be cited, for example, azine compound such as pyridazine, pyrimidiene, pyrazine, orthooxazine, metaoxazine, paraoxazine, orthothiazine, metathiazine, parathiazine, 1,2,3-triazine, 1,2,4-triazine, 1,3 5-triazine, 1,2,4-oxaziazine, 1,3,4-oxaziazine, 1,2,6-oxaziazine, 1,2,6-oxaziazine, 1,3,4-thiaziazine, 1,3,5-thiaziazine, 1,2,3,4-tetrazine, 1,2,4,5-tetrazine, 1,2,3,5-tetrazine, 1,2,4,6-oxatriazine, 1,3,4,5-oxatriazine, phtalazine, quinazoline, quinoxaline, etc.; direct dye consisting of azine compound such as azinefirast red FC, azinefirstred12BK, azineviolet BO, azinebrown 3G, azinelightbrown GR, azinedarkgreen BH/C, azinedeepblack EW, azinedeepblack 3RL, etc.; nigrosine compound such as nigrosine, nigrosine salt, nigrosine derivatives, etc.; acid dye consisting of nigrosine compound such as nigrosin BK, nigrosin NB, nigrosin Z, etc.; metal salt of naphtenic acid or higher fatty acid; amine alkoxylate; alkylamide; and quaternary ammonium salt such as bennzilmethylhexyldecylammonium,decyltrimethylammoniumchlor ide, etc. These can be used as a single agent or combined agent of two or more of these agents. Particularly, nigrosine compound is most suitable for use for positive charging toner from point of view of quick rise of charge amount.

Further, resin or oligomer having quaternary ammonium salt, resin or oligomer having carboxylate salt, and resin or oligomer having carboxyl group can be used as a charge control agent of positive charging property. To be more specific, one or combination of two or more agents can be cited among agents such as polystyrene group resin having quaternary ammonium salt, acryl group resin having quaternary ammonium salt, styrene-acryl group resin having quaternary ammonium salt, polyester group resin having quaternary ammonium salt, polystyrene group resin having carboxylate salt, acryl group resin having carboxylate salt, styrene-acryl group resin having carboxylate salt, polyester group resin having carboxylate salt, polystyrene group resin having carboxyl group, acryl group resin having carboxylate salt, styrene-acryl group resin having carboxyl group, polyester group resin having carboxyl group.

Particularly, styrene-acryl group resin(styrene-acryl group copolymer) having quaternary ammonium salt or carboxylate salt or carboxylate salt as a functional group are suitable for charge control agent, for the charge amount of toner can be easily controlled in a desirable range by these agents. As acryl group monomer which compose styrene-acryl group resin together with styrene can be cited alkylester(meth)acrylate such as methyl acrylate, ethyl acrylate, n-propyl acrylate, isopropyl acrylate, n-butyl acrylate, isobutyl acrylate, 2-ethylhexyl acrylate, methyl methacrylate, ethyl methacrylate, nˆbutyl methacrylate, and isobutyl methacrylate.

Further, as quaternary ammonium salt is used a monomer derived from dialkylaminoalkyl(meth)acrylate through the process of changing to a quaternary compound. Dialkylaminoethyl(meth)acrylate, such as dimethylaminoethyl(meth)acrylate, diethylaminoethyl(meth)acrylate, dipropylaminoethyl(meth)acrylate, dibuthlaminoethyl(meth)acrylate, etc.; dimethylmethacrylamide; and dimethylaminopropylmethacrylamide etc., for example, are suitable for dialkylaminoalkyl(meth)acrylate from which said monomer is derived. Hydroxy group containing monomer such as hydroxiethyl(meth)acrylate, hydroxipropyl(meth)acrylate, 2-hydroxibutyl(meth)acrylate, N-methylol(meth)acrylate, etc. can be used together when polymerizing.

As a charge control agent of negative charging property, an organometalic complex and chylate compound, for example, are effective. Among them, acetylaceton metallic complexes, salicylic acid group metallic complexes or salt are preferable. Among these, as acetylaceton metallic complex can be cited, for example, aluminumacetylacetonat, iron(II)acetylacetonat, etc. As salicylic acid group metallic complexes or salt can be cited, for example, 3,5-di-tert-butylchromesalicylate, etc.

The percentage of the charge control agent in the toner is preferable to be 0.1 to 15% by weight, 0.3 to 8.0% by weight (total weight of toner is taken as 100%) is more preferable, and 0.5 to 7.0% by weight is particularly preferable. When the percentage of the charge control agent is lower than this range, it is difficult to give a stable charging characteristic to the magnetic toner, and there may occur decrease in image density and decrease in durability of the toner. On the contrary, when the percentage exceeds the above defined range, environment resistance of the magnetic toner decreases, particularly deficient charging and degradation of image under high temperature, high humidity tend to occur. Furthermore, there may occur background fogging because of easier occurrence of insufficient dispersion of the charge control agent in the binder resin, and aggregated charge control agent not dispersed in the binder resin may contaminate the photoreceptor drum.

(Wax)

Wax is compounded for improving fixing property of magnetic toner on recording mediums such as paper sheets, preventing offset that magnetic toner adheres to fusing roller, etc. of the image forming apparatus when fusing images to prevent image smearing that the toner adhered to the fusing roller, etc. adheres to the surface of the recording medium and stain the image formed on the recording medium.

As wax can be cited vegetable wax of olefin group such as, for example, polyethylene wax, polypropylene wax, etc.; vegetable wax such as carnauba wax, rice wax, candelila wax; mineral wax such as montan wax, etc.; Fischer-Tropsch wax obtained from char coal or natural gas, etc by Fischer-Tropsch method; petroleum wax such as paraffin wax, microchristarine wax; ester group wax; and fluorocarbon resin group wax. One or combination of two or more kinds of wax can be used.

Percentage of wax contained in a magnetic toner particle is preferable to be 1 to 5% wt (total weight ofmagnetic toner is taken as 100%). When the amount of the wax is less than this range, the effect of wax to increase anti-offset property of magnetic toner and to prevent image smearing may not be obtained sufficiently, on the contrary, when the amount of was exceeds this range, magnetic toner fuses with each other and preservation stability tends to be reduced.

(Magnetic Powder for Internal Addition)

Magnetic powder for external addition may also be used for internal addition, or well known magnetic powder may be used.

As magnetic powder can be cited ferromagnetic metal such as ferrite, magnetite, iron, cobalt, nickel, etc., or their alloy, or composition containing these elements, or alloys not containing ferromagnetic elements but become ferromagnetic by proper heat treatment, or chromium dioxide. These magnetic powder is of average grain size of 0.1-1 μm, preferably 0.1-0.5 μm. The fine grain is dispersed evenly in a magnetic toner binder particle. The magnetic powder may be surface treated by a surface treating agent such as titanium group coupling agent, silane group coupling agent, etc.

It is preferable that the magnetic powder is contained in the magnetic toner by 35-60% wt, more preferably 40-60% wt (total weight of magnetic toner is taken as 100%). When the percentage exceeds 60% wt, image density lowers and fusing property tends to reduce extremely. When the percentage is smaller then 35% wt, background fogging tends to occur and image quality is decreased.

(Magnetic Powder for External Addition)

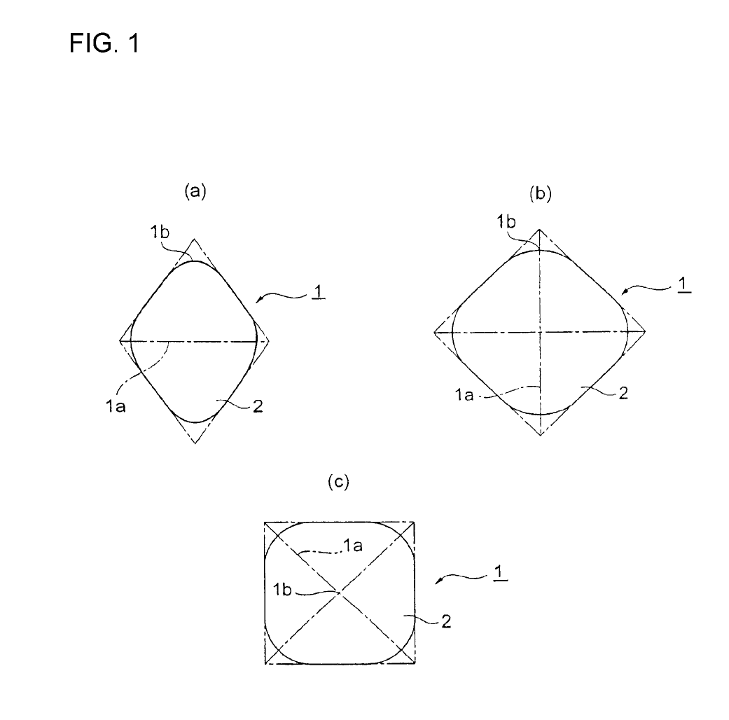

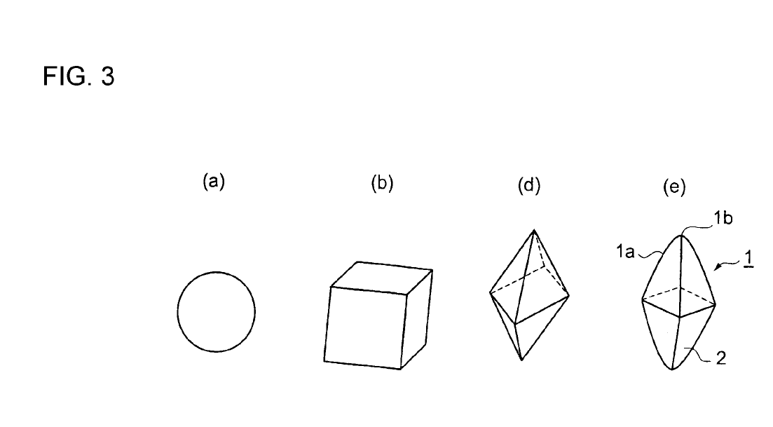

The magnetic single-component toner of the invention is internally added with magnetic powder and at the same time added externally with magnetic powder as mentioned above. The magnetic powder added externally is of grain shape of basically convex octahedron surrounded with 8 triangles and its apexes and ridges are formed into curved surfaces as shown in FIG. 3(e) and FIG. 1, and further the disengagement rate of the magnetic powder is preferable to be 10-25%. The disengagement rate is a ratio of the amount of free iron atoms of the magnetic powder origin to the amount of carbon atoms of the mother particle of the magnetic toner.

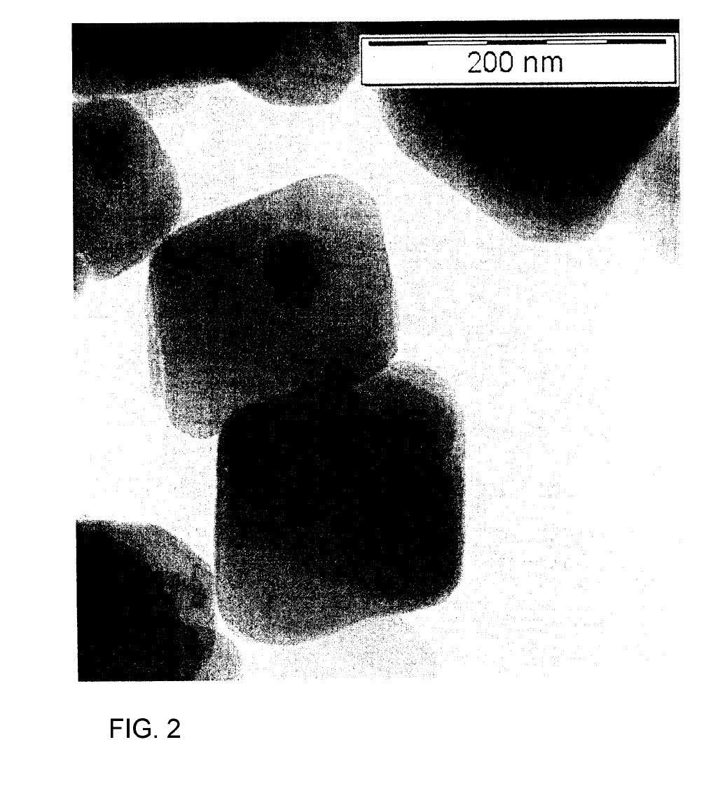

A magnetic powder grain 1 shown in FIG. 1(a)-(c) is basically a convex octahedron surrounded with 8 triangles and its apexes and ridges are formed into curved surfaces. As can be recognized from a photograph (projected figure of magnetic toner grains) taken by a transmission electron microscope (TEM) shown in FIG. 2, the magnetic toner grain of basically octahedral shape is featured in having rounded apexes and ridges instead of pointed apexes and sharp ridges from which electric charge tends to discharge. The grain shape is further characterized in that, portions deemed as straight lines are remaining on the circumference of the projected figure of the grain and the feature of octahedral shape remains as seen in FIG. 2, not that curvature radiuses of the curved surfaces of the apexes and ridges are so large that curved surfaces of the adjacent apexes and ridges nearly continue to each other and straight line parts hardly remain on the circumference of the projected figure of the grain, that is, the grain becomes nearly spherical.

By adding the magnetic powder like this externally tomagnetic toner particles, effect of preventing occurrence of dielectric breakdown on the surface of the a-Si photoreceptor drum 11 can be obtained. However, when the amount of the magnetic powder released from mother particles of the magnetic toner is large, the free magnetic powder (disengaged magnetic powder) adheres to the surface of the magnetic toner carrying body 14₁ and an adhered grain becomes a core around which the magnetic powder aggregates, as a result a thin magnetic toner layer is not formed uniformly on the surface, which may cause crucial image defection. Therefore, the releasing of the magnetic powder must be suppressed.

On the other hand, when the releasing of the magnetic powder is suppressed extremely, the magnetic toner becomes overcharged and dielectric breakdown occurs on the surface of the a-Si photoreceptor drum 11, although the magnetic powder is added externally, and the effect of external addition of the magnetic powder can not be obtained.

Therefore, it is necessary that the amount of the magnetic powder released from the mother particles of magnetic toner remains in a proper range so that defection such as a fault in the formation of thin layer of magnetic toner does not occur due to too many free magnetic powder and overcharge of magnetic toner is suppressed by the presence of free magnetic powder released from the mother particles of the magnetic toner. The proper range of rate of releasing, i.e. disengagement rate of magnetic powder is 10-25% as recited above.

A method of measuring the disengagement rate can be performed by the method disclosed in “Toner analysis by a new particle analyze for evaluating external addition” published in '97 Collected Papers, Japan Hardcopy, 95^{th} annual conference of Japan Society of Electrophotography. In this analysis method, toner particles are introduced into plasma and excited there and the emission spectrum caused by the excitation is detected. With this analysis method, emission spectrums accompanying excitation of a plurality of elements can be detected concurrently, and further periodicity of the emission spectrum also can be determined.

To be more particular, when a toner particle of which the mother particle is added internally with magnetic powder and further added externally with magnetic powder of grain shape of octahedron with its apexes and ridges rounded is introduced into plasma, the mother particle and magnetic powder emit light at the same time because the mother particle and magnetic powder are introduced into the plasma at the same time. When the mother particle and magnetic powder emit light at the same time, it is said the mother particle and magnetic powder are in a synchronized state, which represents a state that the magnetic powder is adhering to the mother particle and not released therefrom.

On the other hand, in the case a mother particle of toner without magnetic powder adhered thereto and free magnetic powder released from the mother particle (the free magnetic powder includes not only externally added magnetic powder but also magnetic powder initially added internally to the mother particle but desorped therefrom) are introduced into plasma, the mother particle and magnetic powder emit light, but as the mother particle and magnetic powder are introduced onto plasma at different time, the mother particle and magnetic powder emit light at different time. For example, if the mother particle is introduced into the plasma earlier than the magnetic powder, the mother particle emits light earlier, and then the magnetic powder emits light belatedly.

In the case the mother particle and magnetic powder emit light at different time, themotherparticle andmagneticpowder are not synchronized, and this is said the mother particle and magnetic powder are in an asynchronized state, which represents a state that the magnetic powder is not adhering to the mother particle and released therefrom.

Concretively, disengagement rate of magnetic powder was measured using DP-1000 particle analyzerofHoriba Mfg. Co. Ltd. made. The condition of measurement was: and disengagement rate of magnetic powder was determined from the synchronism of light emission of iron atom using carbon atoms obtained by setting the number of carbon atoms to be 2500-3000 and analysis wavelength to be 247.86 nm for carbon atom (C atom) and 239.56 nm for iron atom (Fe atom) as a basis and calculating from the following equation (1), wherein, A is disengagement rate of Fe atom (%), N is counted number of Fe atom which did not emit light at the same time with C atom, and M is counted number of Fe atom which emitted light at the same time with C atom.
A(%)=N×100/(N+M) (1)

When disengagement rate obtained in this method is 10-25%, the effect mentioned above can be obtained.

The magnetic powder is needed to be of average grain size of 0.01-0.50 μm. Magnetic powder of average grain size smaller than 0.01 is high in proportion of small grains and strong in cohesive property, so dispersion when mixing is not good, and effect of addition can not be expected. That is, grinding action of the surface of the photoreceptor is deficient and filming of the photoreceptor is not prevented sufficiently.

On the other hand, the magnetic powder of average grain size exceeding 0.50 μm is high in proportion of large grains and wide in distribution of grain size, so grains of small and large grain size exist. Therefore, even adhesion of the magnetic powder to the surface of mother particles of toner becomes difficult, scratches on the surface of the photoreceptor by the magnetic powder tend to occur, as a result there may occur defection in image. Further, fluidity of toner deteriorates, so formation of a layer of toner on the surface of the developing sleeve becomes difficult and the layer become uneven in thickness.

When taking balance of effect into consideration, average grain size of the magnetic powder is preferable to be 0.05-0.35 μm, more preferable to be 0.15-0.30 μm.

Average grain size of the magnetic powder was determined by magnifying grain figures photographed by a transmission electron microscope of magnification of ten thousand by fourfold and averaging martin diameters (diameter corresponding to a circle) of 300 grains.

Volume specific resistance of the magnetic powder is preferable to be 10²-10⁹ Ωcm, more preferably 10³-10⁸ Ωcm, and further preferably 10⁴-10⁷ Ωcm. When the volume specific resistance is smaller than 10² Ωcm, themagnetic toner can not be given sufficient positive charge and image density reduces. When it is larger than 10⁹ Ωcm, themagnetic toner is excessively charged and reduction in image density and reduction in durability are induced. Further, discharge breakdown to the photoreceptor occur by excessive charge-up and black points occur in images.

Volume specific resistance of the magnetic powder can be measured by a R8340A, ULTRA HIGH RESISTANCE METER of ADVANTEST Co. made, applying load of 1 kg and DC 10V.

Further, saturation magnetization of the magnetic powder is preferable to be 70-90 Am²/kg measured at magnetic field of 795.8 kA/m. When the saturation magnetization is lower than 70 Am²/kg, magnetic binding force exerting on themagnetic toner becomes weak, as a result, magnetic powder added externally falls off frommagnetic toner particles when a large number of sheets are printed, and initial condition can not be maintained. When the saturation magnetization exceeds 70 Am²/kg on the contrary, magnetic binding force toward the magnet sleeve becomes stronger than magnetic bonding force toward themagnetic toner, as a result, magnetic powder added externally falls off from the magnetic toner.

Saturation magnetization of the magnetic powder can be measured using a test sample vibration type magnetometer (VSM-P7-15 type, Touei Inds. made).

Additive rate of magnetic powder to the mother particle ofmagnetic toner is preferable to be 0.1-5.0% wt. When the additive rate is smaller than 0.1% wt, grinding power of the magnetic powder grain for grinding the surface of the photoreceptor is deficient and sufficient preventing effect of filming of the photoreceptor can not be obtained. Further, effect of suppressing charge-up in long operation is small and image density reduces, at the same time discharge breakdown the photoreceptor occurs resulting in occurrence of black points in images. When the additive rate exceeds 5% wt, scratches on the surface of the photoreceptor become significant.

As magnetic powder can be cited ferromagnetic metal such as ferrite, magnetite, iron, cobalt, nickel, etc., ortheiralloy, or composition containing these elements, or alloys not containing ferromagnetic elements but become ferromagnetic by proper heat treatment, or chromium dioxide. Among them, magnetic powder consisting of ferrite, magnetite is preferable. Particularly, when taking into consideration to give good magnetic characteristic to the magnetic powder, it is preferable that the magnetic powder consists of magnetite containing at least one element selected from Mn, Zn, Ni, Al, Ti, and Si by an amount corresponding to 0.1 to 10% atom of Fe.

Magnetic powder consisting of magnetite and having polyhedral grain shape with portions deemed as straight lines remained in the projected profile of the grains and average grain size is in the range recited above, can be prepared, for example, by the following method.

26.7 liter of aqueous solution of iron (II) sulfate salt containing 1.5 mol of Fe²⁺ per 1 liter of water is added to 25.9 liter of aqueous solution of sodium hydroxide of 3.4N (which corresponds to 1.1 equivalence to Fe²⁺) prepared in a vessel, and heated to 90° C. to produce a suspension of iron (II) salt containing iron (II) hydroxide colloid while maintaining pH to 10.5.

Then, 100 liter/minute air is blown into the suspension for 80 minutes while maintaining the temperature of the liquid at 90° C. to allow oxidative reaction continue until oxidization percentage of the iron (II) salt reaches 60%. Then, after adding aqueous solution of sulfuric acid to the suspension to reduce pH thereof to 6.5, 100 liter/minute air is blown into for 50 minutes while maintaining the temperature of the liquid at 90° C. to produce magnetite particles in the suspension.

After adding aqueous solution of sodium hydroxide to the suspension containing the magnetite particles so that pH of the suspension becomes 10.5, 100 liter/minute air is blown into for 20 minutes while maintaining the temperature of the liquid at 90° C. Then, the magnetite particles are water-washed and filtered by a usual method to obtain magnetite particles. The magnetite particles are dried and the agglomeration of magnetite particles is crushed. In this way, magnetic powder of which grain shape is basically octahedral with apexes 1b and ridges 1b being curved surfaces is obtained.

In the process described above, by adding water-soluble metallic compound or compounds such as water-soluble silicate by an amount which correspond to 0.1-10% atom of Fe and adjusting pH of the liquid 8.0-9.5 when oxygen-bearing gas blowing into the liquid is started in the first step of reaction, magnetic powder composed of magnetite containing at least one element selected from Mn, Zn, Ni, Cu, Al, Ti, and Si by an amount corresponding to 0.1-10 atom % of Fe is obtained.

Taking into consideration that the magnetic powder is required to have good charge stability against environmental variation, the magnetic powder may be surface-treated with a surface treatment agent such as a coupling agent of titanium group, coupling agent of silane group, coupling agent of aluminum group, and a variety of fatty acids. Among these, the coupling agent of silane group is preferable. There can be cited for example as a specific compound, hexamethyldi silazane, trimethylsilane, trimethylchlorsilane, trimethylethoxysilane, dimethylchlorsilane, aryldimethylchlorsilane, arylphenyldichlorsilane, benzyldimethylchlorsilane, bromomethyldimethylchlorsilane, α-chlorethyltrichlorsilane, β-chlorethyltrichlorsilane, chlormethyldimethylchlorsilane, triorganosilylmercaptan, trimethylsilylmercaptan, triorganosilylacrylete, vinyldimethylacetoxisilane, dimethyldiethoxysilane, dimethyldimethoxysilane, diphenylethoxysilane, hexamethyldisiloxane, 1,3-divinyltetramethyldisilxane, and 1,3-diphenylteramethyldisiloxane, etc.

Dimethylpolysiloxane, etc. having 2-12 siloxane units in one molecule and including a hydroxyl bonding to a silicon at each of siloxane units located at terminal positions of the molecule, can be used.

Volume specific resistance of the magnetic powder can be adjusted by changing kinds of titanium group coupling agents such as silane group coupling agents, aluminum group coupling agents, a variety of fatty acids, or changing the amount of the agent, or forming an electrically conductive coating layer such as tin/antimony, francium, etc.

Further, the saturation magnetization can be adjusted by changing the amount of Fe²⁺ contained in the magnetic powder grain. Generally, the larger the amount of Fe²⁺ contained in the magnetic powder grain is, the larger the saturation magnetization value is. Further, when metal other than Fe, for example, Zn is allowed to be contained in the magnetic powder grain, the saturation magnetization is increased. On the contrary, when Ti is allowed to be contained, the saturation magnetization decreases. Saturation magnetization of the magnetic powder is adjusted by these methods.

The present invention will be explained hereunder. By the way, binder resin, magnetic powder, charge control agents, wax, dyestuff, plasticizer, external additives, etc. in the invention are ones which can be used in magnetic single-component toner and there are no particular restrictions.

(Production of Magnetic Toner)

The magnetic toner of the present invention can be obtained by mixing the binder resin and a variety of additives such as a charge control agent, etc. and melt kneading by using a kneading machine such as an extruder, then cooling the kneaded mixture, crushing, and classifying according to grain size. Thus obtainedmagnetic toner particles are preferable to be of average grain size of 5.0-10.0 μm. If grain size exceeds this range, fluidity of magnetic toner reduces, background fogging occurs, and reduction in image quality is induced.

The magnetic toner thus prepared may be surface-treated as necessary with, for example, fine particle (external additive usually of average grain size of 1.0 μm or smaller) such as colloidal silica, hydrophobic silica, alumina, titanium oxide in order to improve fluidity, preservation stability, cleaning property which is the easiness to be cleaned from the surface of the latent image carrying body), etc. The surface treatment is preferably performed by dry blending the magnetic toner and external additive, and particularly it is preferable to mix by using a Henschel mixer, Nauter mixer, etc. in order to prevent the magnetic powder grains embedded onto the surface of the magnetic toner particles. The amount of external additive is preferable to be 0.2-10.0% wt of the magnetic toner particle. Further, the external additive may be surface-treated as necessary with aminisilane, silicone oil, silane group coupling agents (hexamethyldisilazane, etc.), titanium group coupling agents.

### EMBODIMENTS OF MAGNETIC TONER

Embodiment ofmagnetic toner will be explained hereunder. Of course, the following explanation shall be interpreted as illustrative not as limitative of the scope of the present invention.

<<Investigation Concerning the Shape of Magnetic Powder Grain for External Addition I>>

(Measurement of Average Grain Size)

Average grain size of the magnetic powder was determined by magnifying grain figures photographed by a transmission electron microscope of magnification of ten thousand by fourfold and averaging martin diameters (diameter corresponding to a circle) of 300 grains.

### FIRST EMBODIMENT

(Synthesis of Binder Resin)

Xylene of 300 parts by weight is put in a reaction vessel providedwithathermometer, agitator, nitrogeninductiontube, and return tube, the reaction vessel is heated to maintain the temperature of the liquid in the vessel at 170° C. while introducing nitrogen continuously via the nitrogen induction tube, a solution of styrene of 845 parts by weight, n-butyl acrylate of 155 parts by weight, and di-tert-butylchromesalicylate of 8.5 parts by weight solved in xylene of 125 part by weight is dropped into the reaction vessel in tree hours, after dropping is finished further agitated for 1 hour keeping the temperature at 170° C., then the solvent is removed. In this manner, styrene-n-butylacrylate copolymer as binder resin was prepared.

(Production of Magnetic Toner)

Magnetic powder to be added externally which consists of magnetite containing Zn by an amount corresponding to 1.1% atom of Fe, of which grain shape is basically of convex octahedron surrounded with 8 triangles with apexes and ridges being rounded to be formed into curved surfaces such that portions deemed as straight lines remain on the circumference of the projected figure of the grain as shown i FIG. 3(e), and of which average grain size is 0.20 μm, was added to the mother particles of magnetic toner by 2.0% wt. Volume specific resistance of the magnetic toner was 3×10⁵ Ωcm.

As magnetic powder to be added internally was used magnetic powder which consists of magnetite (Fe₃O₄(FeO.Fe₂O₃), of which grain shape is spherical as shown in FIG. 3(a), and of which grain size is 0.20 μm.

The binder resin synthesized as mentioned above (peak molecular weight of low molecular weight: 7,000, peak molecular weight of high molecular weight: 140,000, grass transition point Tg: 55° C.) of 49 parts by weight, the magnetic powder of 45 parts by weight, Fischer-Tropsch wax (Sazol wax H1 of Sazol Co. made) of 3 parts by weight as a parting agent, and quaternary ammonium salt (bontoron P-51 of Orient Chemical Inds. made) of 3 part by weight were mixed using Henschel mixer, kneaded by a two-axle extruder and cooled, then rough-crushed by a hammer mill. Then, it was fine-crushed by a mechanical crusher, classified by an air-flow type classifier. In this way, magnetic toner of first embodiment of volume base central particle diameter of 8.0 μm was prepared.

### COMPARATIVE EXAMPLE 1

The magnetic toner of comparative example 1 of volume base central particle diameter of 8.0 μm was prepared similarly as the first embodiment was prepared using the same amount of magnetic powder consisting of magnetite of the same composition except that the grain shape of the magnetic powder was a convex octahedron surrounded with 8 triangles with apexes and ridges not rounded as shown in FIG. 3(d) and average grain size was 0.23 μm.

### COMPARATIVE EXAMPLE 2

The magnetic toner of comparative example 2 of volume base central particle diameter of 8.0 μm was prepared similarly as the first embodiment was prepared using the same amount of magnetic powder consisting of magnetite of the same composition except that the grain shape of the magnetic powder was basically a convex octahedron surrounded with 8 triangles with apexes and ridges being rounded such that portions deemed as straight lines do not remain on the circumference of the projected figure of the grain and average grain size was 0.22 μm.

### COMPARATIVE EXAMPLE 3

The magnetic toner of comparative example 3 of volume base central particle diameter of 8.0 μm was prepared similarly as the first embodiment was prepared using the same amount of magnetic powder consisting of magnetite of the same composition except that the grain shape of the magnetic powder was basically a convex octahedron surrounded with 8 triangles with apexes and ridges chamfered to be formed into flat surfaces smaller than the original surfaces of the octahedron and average grain size was 0.20 μm.

### COMPARATIVE EXAMPLE 4

The magnetic toner of comparative example 4 of volume base central particle diameter of 8.0 μm was prepared similarly as the first embodiment was prepared using the same amount of magnetic powder consisting of magnetite of the same composition except that the grain shape of the magnetic powder was a convex hexahedron as shown in FIG. 3(b) and average grain size was 0.20 μm.

### COMPARATIVE EXAMPLE 5

The magnetic toner of comparative example 5 of volume base central particle diameter of 8.0 μm was prepared using the same amount of magnetic powder consisting of magnetite of the same composition similarly as the first embodiment was prepared except that the grain shape of the magnetic powder was a convex hexahedron with apexes and ridges chamfered to be formed into flat surfaces smaller than the original surfaces of the hexahedron and average grain size was 0.20 μm.

### COMPARATIVE EXAMPLE 6

The magnetic toner of comparative example 6 of volume base central particle diameter of 8.0 μm was prepared using the same amount of magnetic powder consisting of magnetite of the same composition similarly as the first embodiment was prepared except that the grain shape of the magnetic powder was a sphere and average grain size was 0.22 μm.

The magnetic powder of which the grain shape is a convex octahedron surrounded with 8 triangles with apexes and ridges not rounded and used in the magnetic toner of comparative example 1, magnetic powder of which the grain shape is a cube and used in the magnetic toner of comparative example 4, and magnetic powder of which the grain shape is a sphere and used in the magnetic toner of comparative example 6, are available in the market. The magnetic powder of which the grain shape is basically a convex octahedron surrounded with 8 triangles with apexes and ridges being rounded such that portions deemed as straight lines do not remain on the circumference of the projected figure of the grain and used in the magnetic toner of comparative example 2, magnetic powder of which the grain shape is basically a convex octahedron surrounded with 8 triangles with apexes and ridges chamfered to be formed into flat surfaces smaller than the original surfaces of the octahedron as shown in FIG. 6(b) of Japanese Laid-Open Patent Application No. 2000-162817 and used in the magnetic toner of comparative example 3, and magnetic powder of which the grain shape is a convex hexahedron with apexes and ridges chamfered to be formed into flat surfaces smaller than the original surfaces of the hexahedron as shown in FIG. 6(f) of Japanese Laid-Open Patent Application No. 2000-162817 and used in the magnetic toner of comparative example 5, can be obtained by controlling pH in oxidation reaction to produce octahedral ferrite (c) having pointed apexes and sharp ridges or hexahedral ferrite (b) having pointed apexes and sharp ridges, as recited in Japanese Laid-Open Patent Application No. 2000-162817.

Magnetic powder used in magnetic toner of comparative examples recited later can also be obtained in the same way.

Magnetic single-component toner for developing electrostatic latent images was obtained by adding silica (RA-200H of Japan Aerosil Co. made) of 1.0 parts by weight and titanium oxide (EC-100 of Titanium Inds. Co. made) of 2.0 parts by weight to 100 parts by weight of each of the toner of the embodiments and comparative examples and mixing by a Henschel mixer.

Using these developing agents and performing printing by a Kyocera made Page Printer FS-3830, initial image characteristic and durability were evaluated and at the same time filming and scratches of the photoreceptor drum were checked with eyes, and charge characteristic was measured. As the latent image carrying body was used an a-Si photoreceptor of layer thickness of 14 μm.

(A) Test Under Normal Temperature Normal Humidity

Said printer was left at rest for 8 hours in an environment of 20° C. and 65% relative humidity, then printing was carried out under the same environment. Each of following characteristic was evaluated

(Image Density)

The density of the image formed using said printer on the first sheet (initial image) of standard pattern of 5% print ratio and the density of the image of standard pattern of 5% print ratio after an original of ISO 4% was printed continuously on 100 thousand sheets (image after endurance printing), were measured by a Macbeth reflection densitometer (RD914 of Gretag Macbeth AG made). Image density of 1.30 or higher was evaluated as acceptable and that lower than 1.30 was as rejectable.

(Background Fogging)

The background parts of the initial image and the image after endurance printing were checked with eyes and background fogging was evaluated by following criteria:
∘: No background fogging is observed.
□: Background fogging is slightly observed.
x: Strong background forging is observed.

(Charge Amount of Toner)

Charge amount (μC/g) of the toner in the developing device was measured after the initial image was formed and after the last image was formed by a charge measuring instrument (Q/M meter 210HS of TREK Co. made).

(Filming of Photoreceptor Drum)

After the original of ISO 4% was printed continuously on 100 thousand sheets, the photoreceptor was observed with eyes and filming of the surface of the photoreceptor drum was evaluated by following criteria:
∘: No filming is observed.
□: Filming is slightly observed.
x: Strong filming is observed.

(Scratch on Photoreceptor)

After the original of ISO 4% was printed continuously on 100 thousand sheets, the photoreceptor was observed with eyes and scratches on the surface of the photoreceptor drum was evaluated by following criteria:
∘: No scratch is observed.
□: Scratches are observed slightly.
x: Many scratches are observed.

(B) Test Under High Temperature and High Humidity

The printer was left at rest for 8 hours in an environment of 33° C. and 85% relative humidity, then printing was performed under the same environment. Image density and toner charge amount were measured, and background fogging, filming and scratches of the surface of the photoreceptor were observed with eyes and evaluated by the same manner as done in the forgoing (1) to (5).

(C) Test Under Low Temperature and Low Humidity

The printer was left at rest for 8 hours in an environment of 10° C. and 20% relative humidity, then printing was performed under the same environment. Image density and toner charge amount were measured, and background fogging, filming and scratches of the surface of the photoreceptor were observed with eyes and evaluated by the same manner as done in the forgoing (1) to (5).

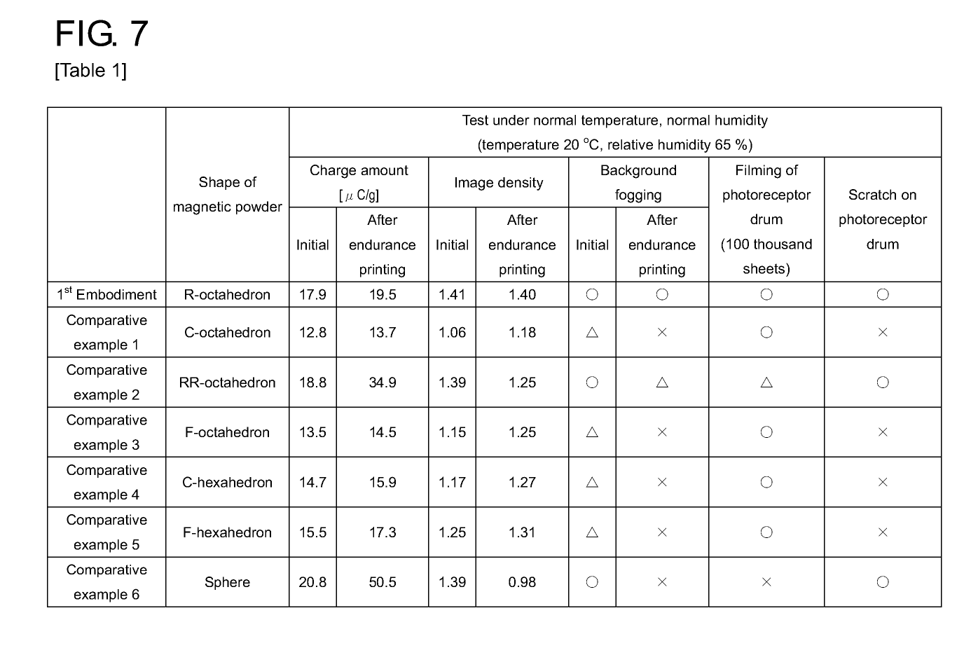

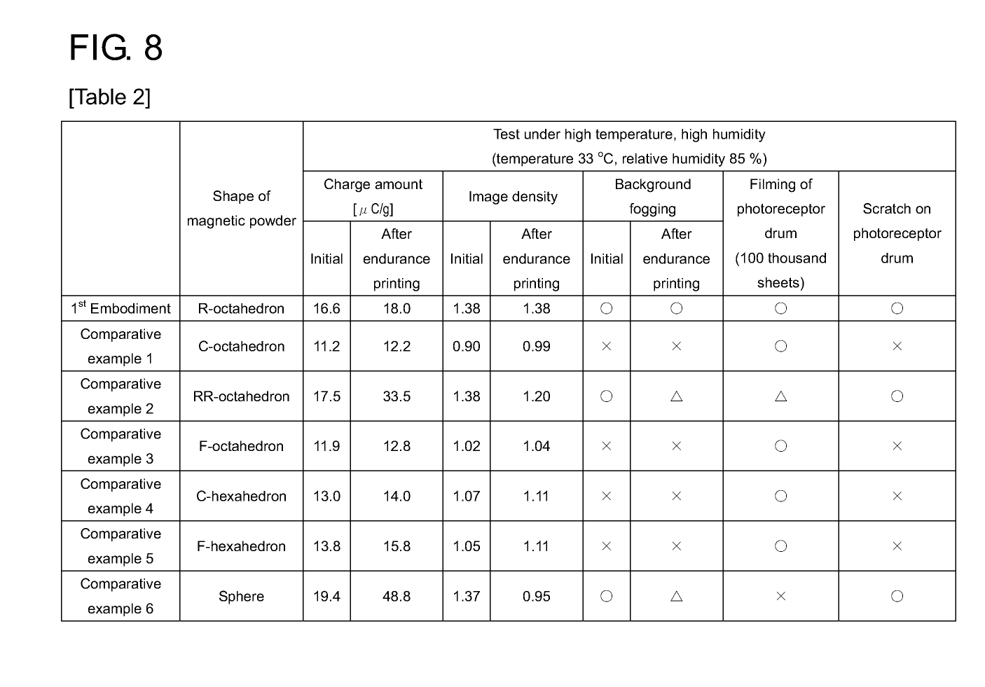

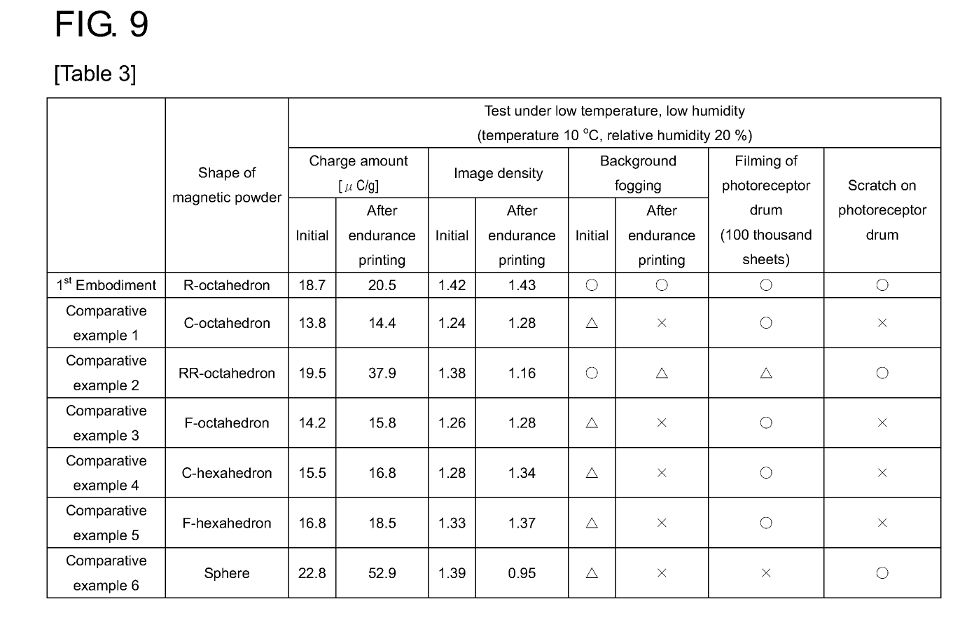

Results of measurement and evaluation when the printing was performed under normal temperature normal humidity are shown in Table 1 of FIG. 7, those under high temperature and high humidity are shown in Table 2 of FIG. 8, and those under low temperature and low humidity are shown in Table 3 of FIG. 9. Abbreviation for grain shape of magnetic powder is as follows:
R-octahedron: Octahedral, with apexes and ridges being rounded to be formed into curved surfaces such that portions deemed as straight lines remain on the circumference of the projected figure of the grain.
C-octahedron: Octahedral, with apexes and ridges not rounded, i.e. usual octahedron.
RR-octahedron: Octahedral, with apexes and ridges being rounded to be formed into curved surfaces of large curvature radiuses such that portions deemed as straight lines do not remain on the circumference of the projected figure of the grain.
F-octahedron: Octahedral, with apexes and ridges chamfered to be formed into small flat surfaces.
C-hexahedron: Hexahedral, with apexes and ridges not rounded, i.e. usual hexahedron.
F-hexahedron: Hexahedral, with apexes and ridges chamfered to be formed into small flat surfaces.
Sphere: Spherical shape.

As can be recognized from Tables 1-3 of FIGS. 7-9, in the cases of toner of both the comparative example 1 in which magnetic powder of octahedral grain shape with apexes and ridges not rounded was used, and of the comparative example 3 in which magnetic powder of octahedral grain shape with apexes and ridges chamfered to be formed into small flat surfaces was used, initial charge amount is small, image density was low, and background fogging occurred, particularly background fogging occurred prominently after the endurance printing under all of tested environments, that is, under normal temperature normal humidity, high temperature high humidity, and low temperature low humidity. Accordingly, it is ascertained that charge leak occurred via magnetic powder added internally to the toner. Although filming of the photoreceptor was not observed, many scratches were observed.

In the case of the toner of comparative example 4 in which magnetic powder of hexahedral grain shape was used, and of comparative example 5 in which magnetic powder of hexahedral grain shape with apexes and ridges chamfered to be formed into small surfaces was used, also initial charge amount is small, image density was low, and background fogging occurred, particularly background fogging occurred prominently after the endurance printing under all of environments of normal temperature normal humidity, high temperature high humidity, and low temperature low humidity. Accordingly, it is ascertained that charge leak occurred via magnetic powder added internally to the toner. Although filming of the photoreceptor was not observed, many scratches were observed.

In the case of the toner of comparative example 2 in which the magnetic powder of octahedral grain shape with apexes and ridges rounded by too large curvature radius that portions deemed as straight lines do not remain on the circumference of the projected figure of the grain was used, and of comparative example 6 in which magnetic powder of spherical grain shape was used, charge amount after the endurance printing rose conspicuously and also image density lowers and background fogging occurred under all of tested environments, that is, under normal temperature normal humidity, high temperature high humidity. Accordingly, it is ascertained that charge leak did not occur via magnetic powder added internally to the toner and charge-up occurred. Although no scratch was observed, filming was observed slightly.

On the contrary, in the case of the toner of the first embodiment in which magnetic powder of octahedral grain shape with apexes and ridges being rounded to be formed into curved surfaces such that portions deemed as straight lines remain on the circumference of the projected figure of the grain, charge amount and image density were nearly the same both at initial stage and after the endurance printing and background fogging did not occur resulting in the formation of high quality images under all of tested environments, that is, under normal temperature normal humidity, high temperature and humidity and low temperature low humidity. No scratch and filming were observed.

<<Investigation Concerning the Shape of Magnetic Powder Grain for External Addition H>>

### SECOND-FIFTH EMBODIMENTS AND COMPARATIVE EXAMPLES 7-8

Six kinds of magnetic toner of volume base central particle diameter of 8.0 μm were prepared similarly as the first embodiment was prepared using the same amount of magnetic powder consisting of magnetite of the same composition as was in the first embodiment and same in grain shape but different in average grain size one another. Grain shape of magnetic powder used was a convex octahedron surrounded with 8 triangles with apexes and ridges being rounded to be formed into curved surfaces such that portions deemed as straight lines remain on the circumference of the projected figure of the grain. Average grain size of magnetic powder was 0.004 μm for comparative example 7, 0.014 μm for the second embodiment, 0.088 μm for the third embodiment, 0.30 μm for the fourth embodiment, 0.37 μm for the fifth embodiment, and 0.63 μm for comparative example 8.

Magnetic single-component toner for developing electrostatic latent images was obtained by adding silica ((RA-200H of Japan Aerosil Co. made) of 1.0 parts by weight and titanium oxide (EC-100 of Titanium Inds. Co. made) of 2.0 parts by weight to 100 parts by weight of each of the toner of the embodiments and comparative examples and mixing by a Henschel mixer.

Using these developing agents and performing printing by a Kyocera made Page Printer FS-3830 installed with an a-Si photoreceptor under normal temperature normal humidity, high temperature high humidity, and low temperature low humidity, initial image characteristic and durability were evaluated, and at the same time filming and scratches of the photoreceptor drum were checked with eyes, and charge characteristic was measured. As the latent image carrying body was used an a-Si photoreceptor of layer thickness of 14 μm.

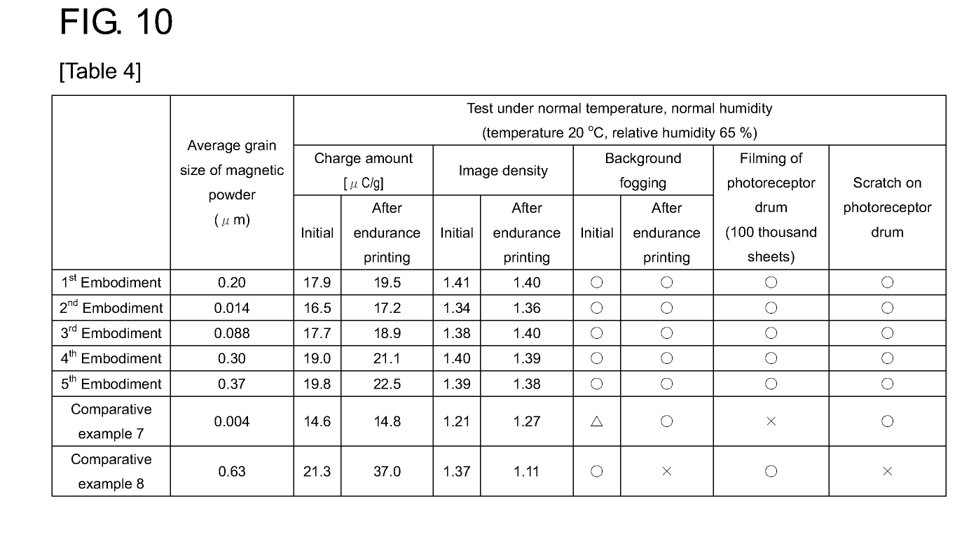

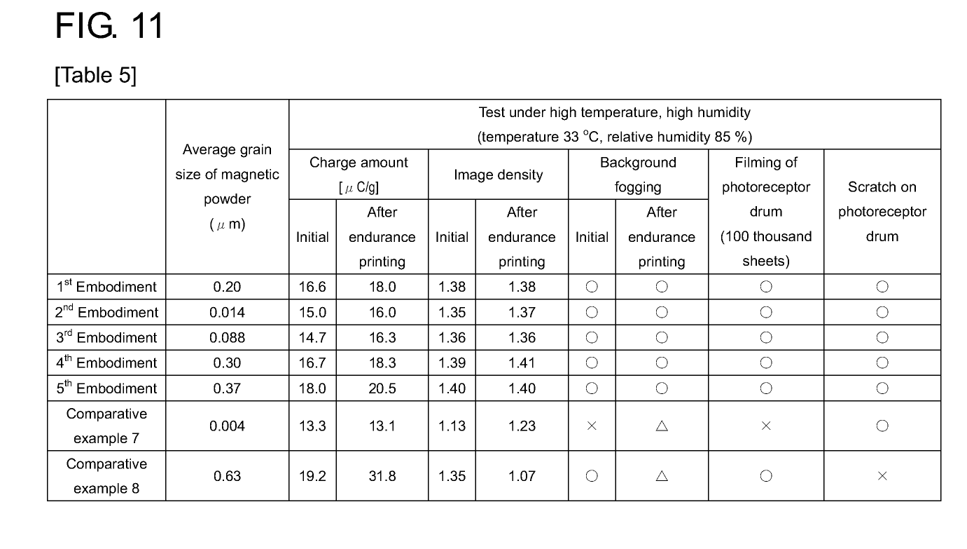

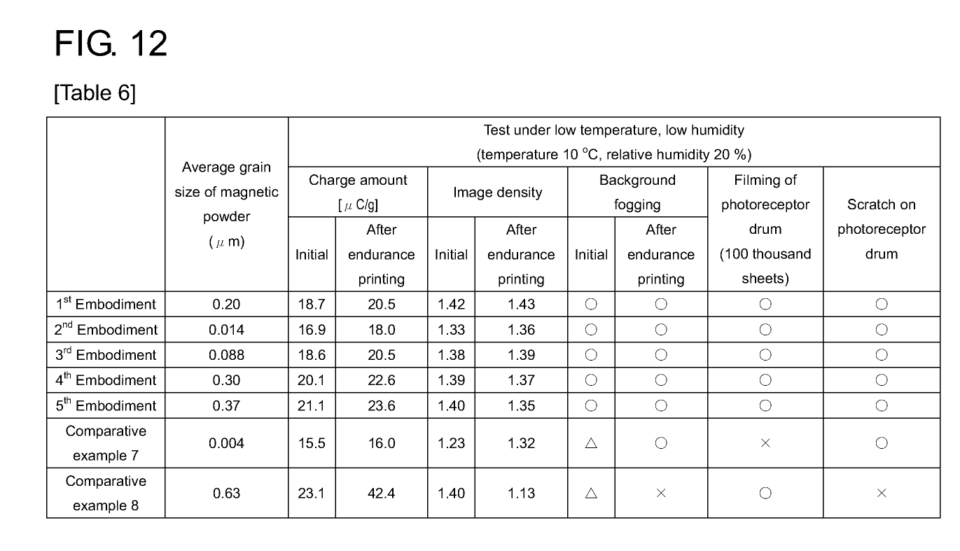

Results are shown in Tables 4-6 of FIGS. 10-12 together with the result of the first embodiment.

As recognized from Tables 4-6, in the case of the toner of comparative example 7 in which although magnetic powder was of octahedral grain shape with apexes and ridges being rounded to be formed into curved surfaces such that portions deemed as straight lines remain on the circumference of the projected figure of the grain but average grain size was smaller than 0.01 μm, initial image density was lower than 1.30 under all of the tested environments, and image density after the endurance printing was lower than 1.30 under normal temperature normal humidity and under high temperature high humidity. Further, background fogging occurred under high temperature and humidity, and furthermore, filming of the photoreceptor occurred under all of the tested environments.

Further, in the case of the toner of comparative example 8 in which although magnetic powder was of octahedral grain shape with apexes and ridges being rounded to be formed into curved surfaces such that portions deemed as straight lines remain on the circumference of the projected figure of the grain but its average grain size exceeds 0.50 μm, charge amount increased, image density decreased, and background fogging occurred after the endurance printing. Accordingly, it is ascertained that charge-up occurred. Scratches were observed on the surface of the photoreceptor drum.

On the other hand, in the cases of the toner of the first to fifth embodiments in which magnetic powder was of octahedral grain shape with apexes and ridges being rounded to be formed into curved surfaces such that portions deemed as straight lines remain on the circumference of the projected figure of the grain and their average grain size are in a range of 0.01-0.50 μm, charge amount and image density were nearly the same both at initial stage and after the endurance printing and background fogging did not occur resulting in the formation of high quality images under all of tested environments, that is, under normal temperature normal humidity, high temperature and humidity and low temperature low humidity. No scratch and filming were observed.

It was revealed that there is a tendency that the smaller the average grain size is, the lower the initial charge is, that, on the contrary, the larger the average grain size is, the higher the charge amount is after endurance printing particularly under low temperature and humidity environment. As a result of the tests, it is ascertained that average grain size of magnetic powder is preferable to be 0.05-0.35 μm and more preferable to be 0.15-0.30 μm.

<<Investigation Concerning the Shape of Magnetic Powder Grain for External Addition III>>

### SIXTH-NINTH EMBODIMENTS AND COMPARATIVE EXAMPLES 9-10

Six kinds of magnetic toner of volume base central particle diameter of 8.0 μm were prepared similarly as the first embodiment was prepared using the same amount of magnetic powder consisting of magnetite of the same composition as was in the first embodiment and same in grain shape but different in average grain size one another. Grain shape of magnetic powder used was a convex octahedron surrounded with 8 triangles with apexes and ridges being rounded to be formed into curved surfaces such that portions deemed as straight lines remain on the circumference of the projected figure of the grain. Volume specific resistance of magnetic powder was 2×10¹ Ωcm for comparative example 9, 5×10² Ωcm for the sixth embodiment, 7×10⁴ Ωcm for the seventh embodiment, 1×10⁷ Ωcm for the eighth embodiment, 3×10⁹ Ωcm for the ninth embodiment, and 8×10¹⁰ Ωcm for comparative example 10.

Magnetic single-component toner for developing electrostatic latent images was obtained by adding silica ((RA-200H of Japan Aerosil Co. made) of 1.0 parts by weight and titanium oxide (EC-100 of Titanium Inds. Co. made) of 2.0 parts by weight to 100 parts by weight of each of the toner of the embodiments and comparative examples and mixing by a Henschel mixer.

Using these developing agents and performing printing by a Kyocera made Page Printer FS-3830 installed with an a-Si photoreceptor under normal temperature normal humidity, initial image characteristic and durability were evaluated and at the same time black points filming and scratches of the photoreceptor drum were checked with eyes, and charge characteristic was measured. As the latent image carrying body was used an a-Si photoreceptor of layer thickness of 14 μm.

(Black Points on Photoreceptor Drum)

Number of occurrence of dielectric breakdown was evaluated by counting using a dot analyzer (DA-5000S of Ouji Manufacture Co. made) number of black points on recording sheets, which black point occurs due to dielectric breakdown on the photoreceptor, after 100 thousand sheets were printed by the Page Printer. Measurement range of black points was 5 mm×210 mm on sheets of A4 size in lateral direction.

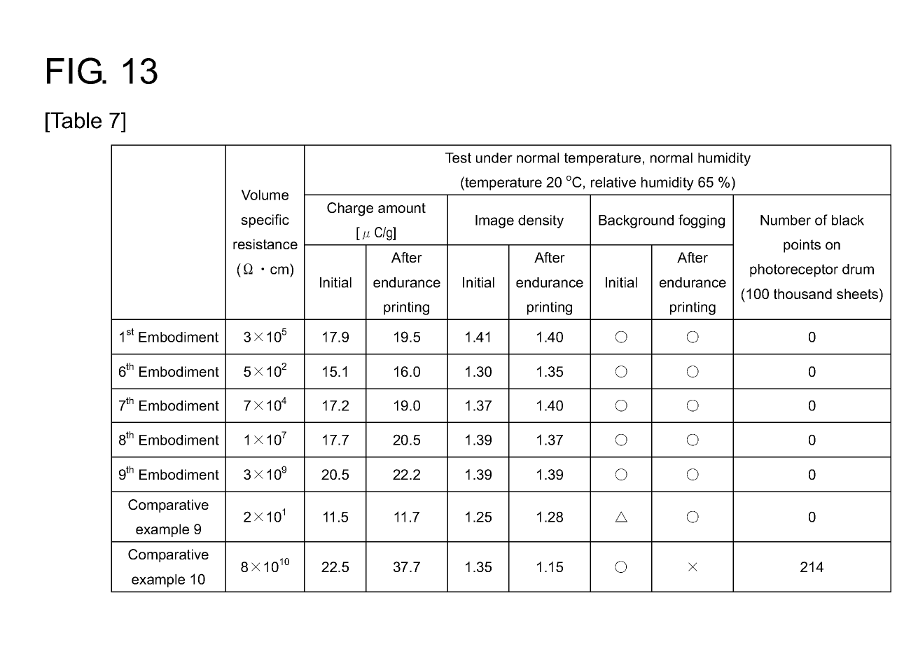

Results are shown in Table 7 of FIG. 13.

As can be recognized from Table 7, in the cases of toner of the first, and sixth-ninth embodiments (volume specific resistance was in a range of 5×10²-3×10⁹ Ωcm, charge amount, image density, and background fogging were good and black points did not occur on the photoreceptor. On the contrary, in the case volume specific resistance was low as 2×10¹ Ωcm (comparative example 9), although no black point occurred but background fogging occurred in the initial image. The reason of this is thought that, as volume specific resistance of the magnetic powder is low, charge amount was small at the initial stage and background fogging occurs, but charge amount increases as printing is continued, so background fogging tends not to occur.

In the case volume specific resistance was high as 8×10⁰ Ωcm (comparative example 10), black points occurred and background fogging occurred after the endurance printing. From these results, it is ascertained that volume specific resistance of the magnetic powder is preferable to be 10²-10⁹ Ωcm, more preferably 10³-10⁸ Ωcm.

>>Investigation Concerning the Shape of Magnetic Powder Grain for External Addition IV>>

### FIRST AND EIGHT EMBODIMENTS AND COMPARATIVE EXAMPLES 11-14

Toner of comparative examples 11-14 added with external additives other than magnetic powder were prepared and compared with the first and eighth embodiments. External additive used for each of comparative examples was; titanium oxide of volume specific resistance of 3×10⁵ Ωcm for comparative example 11, titanium oxide of 3×10⁵ Ωcm for comparative example 12, zinc oxide of 3×10⁵ Ωcm for comparative example 13, zinc oxide of 1×10⁷ Ωcm for comparative example 14. Toner of comparative examples 11-14 of volume base central particle diameter of 8.0 μm were prepared using the same amount of these external additives as abrasive powder in the same manner as the toner of the first embodiment was prepared.

Magnetic single-component toner for developing electrostatic latent images was obtained by adding silica ((RA-200H of Japan Aerosil Co. made) of 1.0 parts by weight and titanium oxide (EC-100 of Titanium Inds. Co. made) of 2.0 parts by weight to 100 parts by weight of each of the toner of the embodiments and comparative examples and mixing by a Henschel mixer.

Using these developing agents and performing printing by a Kyocera made Page Printer FS-3830 installed with an a-Si photoreceptor under normal temperature normal humidity, filming of the photoreceptor drum, black points on photoreceptor, and adhesion of external additive were evaluated. As the latent image carrying body was used an a-Si photoreceptor of layer thickness of 14 μm.

(Filming of Photoreceptor Drum)

After an original of ISO 4% was printed on 300 thousand sheets continuously, the photoreceptor was checked by eyes, and occurrence of filming of the photoreceptor drum was evaluated by following criteria:
∘: No filming is observed.
□: Filming is slightly observed.
x: Strong filming is observed.

(Black Points on Photoreceptor)

Number of occurrence of dielectric breakdown was evaluated by counting using a dot analyzer (DA-5000S of Ouji Manufacture Co. made) number of black points on recording sheets, which black point occurs due to dielectric breakdown on the photoreceptor, after 300 thousand sheets were printed by the Page Printer. Measurement range of black points was 5 mm×210 mm on sheets of A4 size in lateral direction.

(Observation of Adhesion of External Additive Onto the Surface of Toner Particle)

After the original of ISO 4% was printed on 300 thousand sheets continuously, the toner was observed by a scanning electron microscope, and adhesion of external additive onto the surfaces of toner particles was evaluated by following criteria:
∘: Adhered condition of external additive onto toner particle surfaces is the same at the initial condition.
□: The external additive is peeled off slightly compared with the initial condition.
x: Almost all of the external additive is peeled off compared with the initial condition.

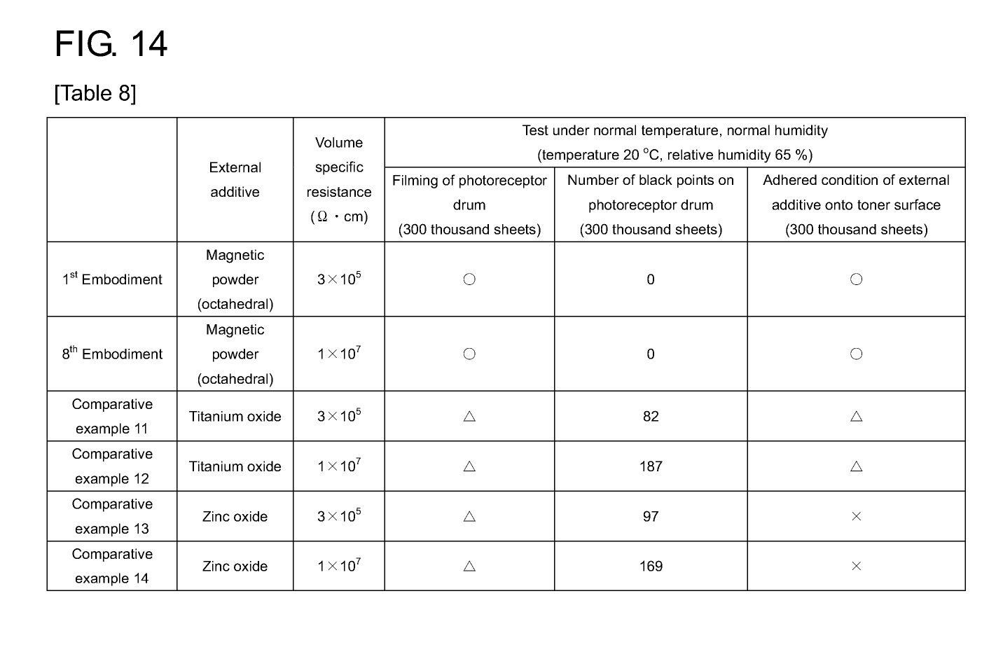

Results of evaluation are shown in Table 8 of FIG. 14. It can be recognized from Table 8 that in the cases of comparative examples 11-14 in which toner is externally added with non-magnetic inorganic metal powder, adhesion of the external additive onto the toner particle is weak due to absence of magnetic force, so the external additive peeled off from the surfaces of toner particle during repeated use and initial adhesion could not be maintained, causing problems in filming of the photoreceptor drum, black points, and adhesion of external additive onto surfaces of toner particles. On the contrary, in the cases of toner of the first and eighth embodiment in which toner is externally added with magnetic powder having magnetic force, so the external additive tends to be retained onto the surface of toner particle by virtue of the magnetic force for a long period, as a result, the initial condition of adhesion of toner onto the toner particle was maintained until after the endurance printing.

<<Investigation Concerning the Shape of Magnetic Powder Grain for External Addition V>>

### TENTH EMBODIMENT

Magnetic powder to be added externally which consists of magnetite containing Zn by an amount corresponding to 1.1% atom of Fe, of which grain shape is basically of convex octahedron surrounded with 8 triangles with apexes and ridges being rounded to be formed into curved surfaces such that portions deemed as straight lines remain on the circumference of the projected figure of the grain as shown i FIG. 3(e), and of which average grain size is 0.23 μm, was added to the mother particles of toner by 2.0% wt. Volume specific resistance of the toner was 7×10⁵ Ωcm.

As magnetic powder to be added internally was used magnetic powder consisting of magnetite of the same composition as used in the first embodiment, of which grain shape is spherical as shown in FIG. 3(a), and of which grain size is 0.20 μm. Same binder resin as used in the first embodiment of 40 parts by weight, the magnetic powder of 45 parts by weight, Fischer-Tropsch wax (Sazol wax H1 of Sazol Co. made) of 3 parts by weight as a parting agent, and quaternary ammonium salt (bontoron P-51 of Orient Chemical Inds. made) of 3 part by weight were mixed using Henschel mixer, kneaded by a two-axle extruder and cooled, then rough-crushed by a hammer mill. Then, it was fine-crushed by a mechanical crusher, classified by an air-flow type classifier. In this way, toner of volume base central particle diameter of 8.0 μm was prepared.

### COMPARATIVE EXAMPLE 15

The magnetic toner of comparative example 15 of volume base central particle diameter of 8.0 μm was prepared similarly as the tenth embodiment was prepared using the same amount of magnetic powder consisting of magnetite of the same composition except that the grain shape of the magnetic powder was a convex octahedron surrounded with 8 triangles with apexes and ridges not rounded as shown in FIG. 3(d) and its average grain size was 0.26 μm.

### COMPARATIVE EXAMPLE 16

The magnetic toner of comparative example 16 of volume base central particle diameter of 8.0 μm was prepared similarly as the tenth embodiment was prepared using the same amount of magnetic powder consisting of magnetite of the same composition except that the grain shape of the magnetic powder was a convex octahedron surrounded with 8 triangles with apexes and ridges being rounded to be formed into curved surfaces such that portions deemed as straight lines do not remain on the circumference of the projected figure of the grain and its average grain size was 0.25 μm.

### COMPARATIVE EXAMPLE 17

The magnetic toner of comparative example 17 of volume base central particle diameter of 8.0 μm was prepared similarly as the tenth embodiment was prepared using the same amount of magnetic powder consisting of magnetite of the same composition except that the grain shape of the magnetic powder was a convex octahedron surrounded with 8 triangles with apexes and ridges chamfered to be formed into flat surfaces smaller than the original surfaces of the octahedron and its average grain size was 0.22 μm.

### COMPARATIVE EXAMPLE 18

The magnetic toner of comparative example 18 of volume base central particle diameter of 8.0 μm was prepared similarly as the tenth embodiment was prepared using the same amount of magnetic powder consisting of magnetite of the same composition except that the grain shape of the magnetic powder was a convex hexahedron as shown in FIG. 3(b) and its average grain size was 0.22 μm.

### COMPARATIVE EXAMPLE 19

The magnetic toner of comparative example 19 of volume base central particle diameter of 8.0 μm was prepared using the same amount of magnetic powder consisting of magnetite of the same composition similarly as the tenth embodiment was prepared except that the grain shape of the magnetic powder was a convex hexahedron with apexes and ridges chamfered to be formed into flat surfaces smaller than the original surfaces of the hexahedron and its average grain size was 0.24 μm.

### COMPARATIVE EXAMPLE 20

The magnetic toner of comparative example 20 of volume base central particle diameter of 8.0 μm was prepared using the same amount of magnetic powder consisting of magnetite of the same composition similarly as the tenth embodiment was prepared except that the grain shape of the magnetic powder was a sphere and its average grain size was 0.24 μm.

Magnetic single-component toner for developing electrostatic latent images was obtained by adding silica ((RA-200H of Japan Aerosil Co. made) of 1.0 parts by weight and titanium oxide (EC-100 of Titanium Inds. Co. made) of 2.0 parts by weight to 100 parts by weight of each of the toner of the embodiments and comparative examples and mixing by a Henschel mixer.

Using these developing agents and performing printing by a Kyocera made Page Printer installed with an a-Si photoreceptor FS-3830 remodeled, initial image characteristic and durability were evaluated and at the same time filming and scratches of the photoreceptor drum were checked with eyes, and charge characteristic was measured. The remodeled Page Printer is installed with an amorphous silicon photoreceptor of layer thickness of 14 μm and the developing device was replaced by the one provided with a developing sleeve of SUS 305 of which surface roughness Rz is 4.0 μm.

Image density, background fogging, and toner charge amount were measured under normal temperature normal humidity environment in the same manner as done in the forgoing tests.

(Condition of Thin Toner Layer)

After an original of ISO 4% is printed on 100 thousand sheets continuously, condition of thin toner layer was checked by eyes and evaluated by following criteria:
∘: Thin layer is formed uniformly without irregularity.
□: Thicker part or parts are observed.
: Uneveness in thickness is observed.

Image density, background fogging, and toner charge amount were measured and also under high temperature high humidity and low temperature low humidity environment and condition of thin layer of toner was evaluated.

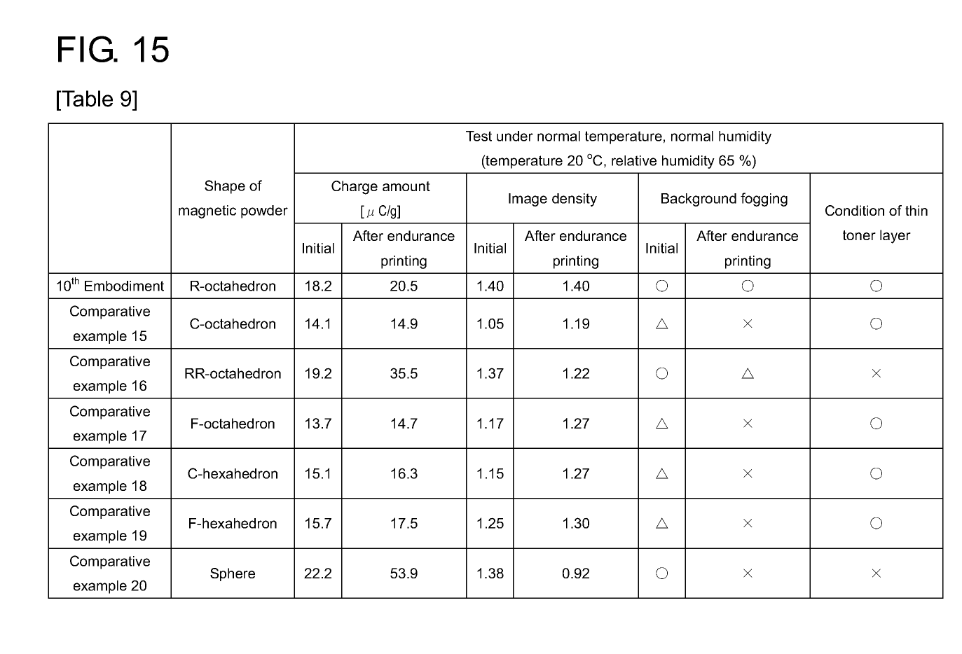

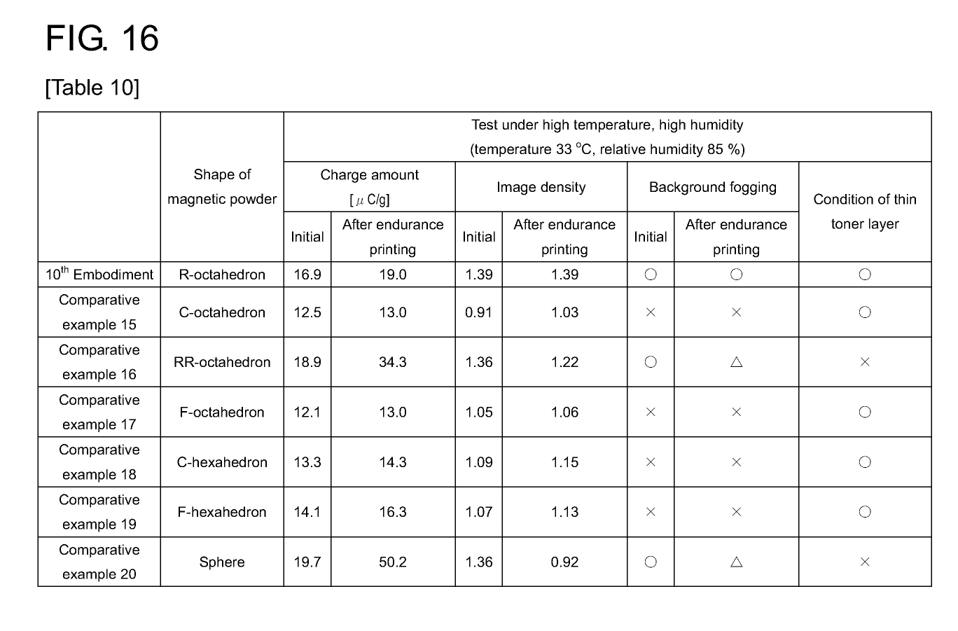

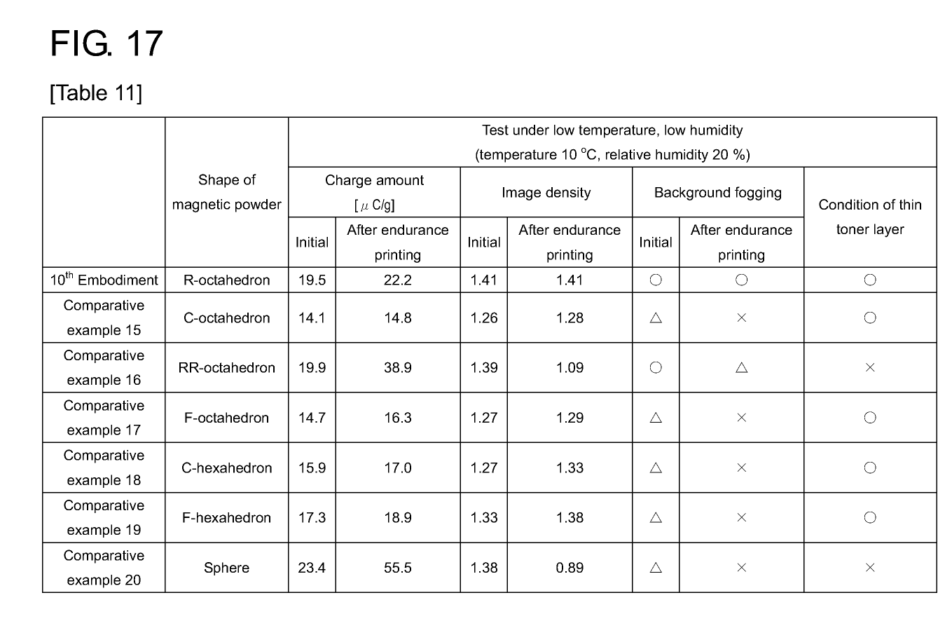

Test results under normal temperature normal humidity are shown in Table 9 of FIG. 15, those under high temperature high humidity in Table 10 of FIG. 16, and those under low temperature low humidity in Table 11 of FIG. 17. Abbreviation for grain shape of magnetic powder has been explained before.

As can be recognized from Tables 9-11, in the case of toner of comparative example 15 in which the grain shape of the magnetic powder is a octahedron with apexes and ridges not rounded, and in the case of toner of comparative example 17 in which the grain shape of the magnetic powder was a octahedron with apexes and ridges chamfered to be formed into small flat surfaces, initial charge amount is remarkably small, image density is low, and background fogging is observed which is aggravated after the endurance printing in any of tests under normal temperature normal humidity, high temperature high humidity and low temperature low humidity. Accordingly, it is ascertained that charge leak occurred from the magnetic powder internally added to toner.

In the case of toner of comparative example 18 in which magnetic powder of hexahedral grain shape was used, and in the case of toner of comparative example 19 in which magnetic powder of octahedral grain shape with apexes and ridges chamfered to be formed into small surfaces, initial charge amount is remarkably small, image density is low, and background fogging is observed which is aggravated after the endurance printing in any of tests under normal temperature normal humidity, high temperature high humidity and low temperature low humidity. Accordingly, it is ascertained that charge leak occurred from the magnetic powder internally added to toner.

Further, in the case of toner of comparative example 16 in which magnetic powder of octahedral grain shape with apexes and ridges being rounded to be formed into curved surfaces such that portions deemed as straight lines do not remain on the circumference of the projected figure of the grain was used, and in the case of toner of comparative example 20 in which magnetic powder of spherical grain shape was used, charge amount is remarkably increased, image density is decreased, and background fogging occurred after the endurance printing in any of tests under normal temperature normal humidity, high temperature high humidity and low temperature low humidity. Accordingly, it is ascertained that discharge from the magnetic powder internally added to toner did not occur and charge-up occurred. Further, condition of thin toner layer is aggravated.

On the other hand, in the case of toner of the tenth embodiment in which the grain shape of magnetic powder was an octahedron with apexes and ridges being rounded to be formed into curved surfaces such that portions deemed as straight lines remain on the circumference of the projected figure of the grain, charge amount and image density were nearly the same both at initial stage and after the endurance printing, background fogging did not occur, and condition of thin layer of toner remained good, resulting in the formation of high quality images under all of tested environments, that is, under normal temperature normal humidity, high temperature high humidity, and low temperature low humidity.

<<Investigation Concerning the Shape of Magnetic Powder Grain for External Addition VI>>

### ELEVENTH-FOURTEENTH EMBODIMENTS, AND COMPARATIVE EXAMPLE 21 and 22

Six kinds of magnetic toner of volume base central particle diameter of 8.0 μm were prepared similarly as the tenth embodiment was prepared using the same amount of magnetic powder consisting of magnetite of the same composition as was in the tenth embodiment and same in grain shape but different in average grain size one another. Grain shape of magnetic powder used was a convex octahedron surrounded with 8 triangles with apexes and ridges being rounded to be formed into curved surfaces such that portions deemed as straight lines remain on the circumference of the projected figure of the grain. Average grain size of magnetic powder was 0.005 μm for comparative example 21, 0.015 μm for the eleventh embodiment, 0.092 μm for the twelfth embodiment, 0.35 μm for the thirteenth embodiment, 0.42 μm for the fourteenth embodiment, and 0.68 μm for comparative example 22.

Magnetic single-component toner for developing electrostatic latent images was obtained by adding silica ((RA-200H of Japan Aerosil Co. made) of 1.0 parts by weight and titanium oxide (EC-100 of Titanium Inds. Co. made) of 2.0 parts by weight to 100 parts by weight of each of the toner of the embodiments and comparative examples and mixing by a Henschel mixer.

Using these developing agents and performing printing by a Kyocera made Page Printer FS-3830 installed with an a-Si photoreceptor under normal temperature normal humidity, high temperature high humidity, and low temperature low humidity, initial image characteristic and durability were evaluated and at the same time filming and scratches of the photoreceptor drum were checked with eyes, and charge characteristic was measured. A developing sleeve made of SUS 305 was used of which surface roughness Rz was 4.0 μm.

(Filming of Photoreceptor Drum)

After the original of ISO 4% is printed continuously on 100 thousand sheets, the photoreceptor was observed with eyes and filming of the surface of the photoreceptor drum was evaluated by following criteria.
∘: No filming is observed.
□: Filming is slightly observed.
x: Strong filming is observed.

(Scratch on Photoreceptor)

After the original of ISO 4% is printed continuously on 100 thousand sheets, the photoreceptor was observed with eyes and scratches on the surface of the photoreceptor drum was evaluated by following criteria.
∘: No scratch is observed.
□: Scratches are observed slightly.
x: Many scratches are observed.

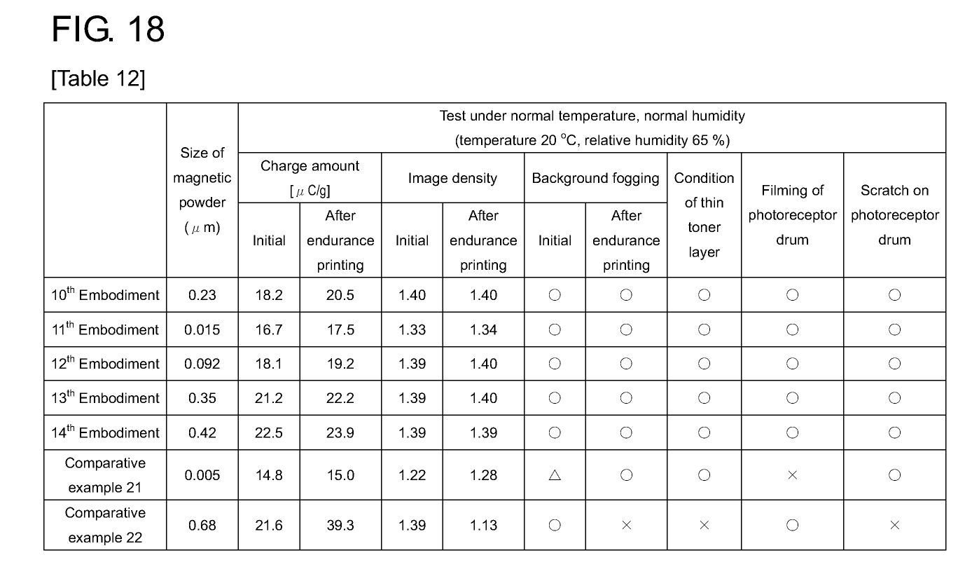

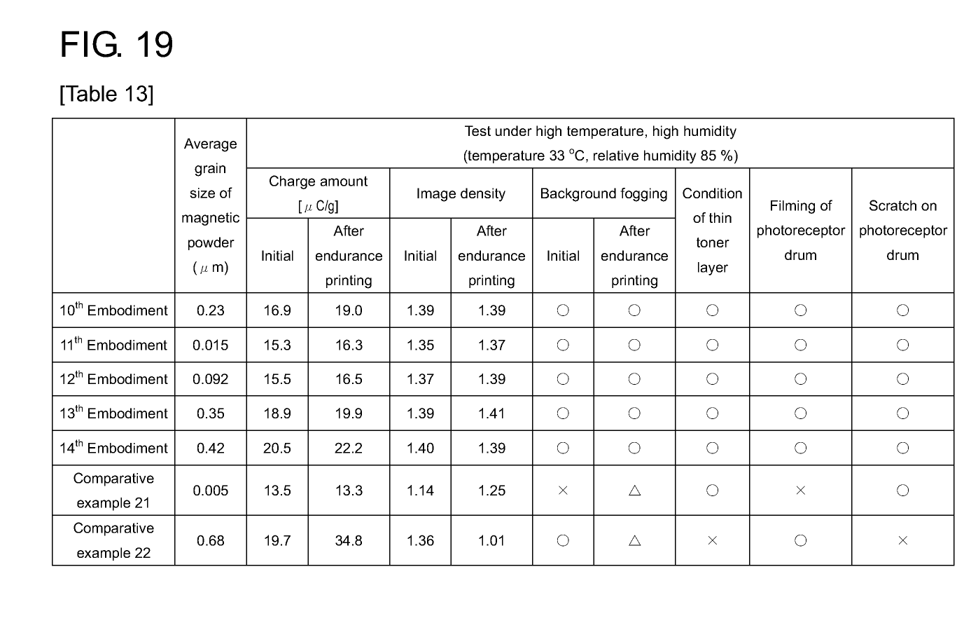

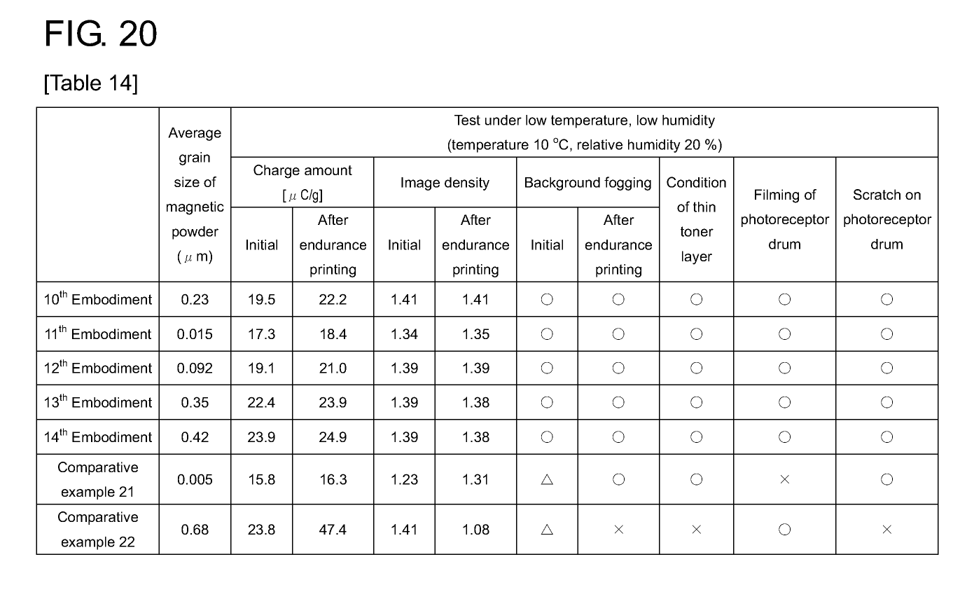

Results are shown in Tables 12-14 of FIGS. 18-20 together with the result of the tenth embodiment.

As can be recognized from Tables 12-14, in the case of toner of comparative example 21 in which although magnetic toner of octahedral grain shape with apexes and ridges being rounded to be formed into curved surfaces such that portions deemed as straight lines remain on the circumference of the projected figure of the grain was used but its average grain size was smaller than 0.01 μm, initial image density is lower than 1.30 in the tests under each environment, image density after endurance printing is smaller than 1.30 in the tests under normal temperature normal humidity and high temperature high humidity. Further, background fogging occurred under high temperature high humidity, and filming of the photoreceptor occurred in each environment.

In the case of the toner of comparative example 22 in which although magnetic powder was of octahedral grain shape with apexes and ridges being rounded to be formed into curved surfaces such that portions deemed as straight lines remain on the circumference of the projected figure of the grain but its average grain size exceeds 0.50 μm, charge amount increased, image density decreased, and background fogging occurred after the endurance printing. Accordingly, it is ascertained that charge-up occurred. Condition of thin layer of toner was deteriorated and scratches were observed on the surface of the photoreceptor drum.

On the contrary, in the cases of toner of the tenth and eleventh-fourteenth embodiments in each of which magnetic powder was of octahedral grain shape with apexes and ridges being rounded to be formed into curved surfaces such that portions deemed as straight lines remain on the circumference of the projected figure of the grain and their average grain sizes were in a range of 0.01-0.50 μm, charge amount and image density were nearly the same both at initial stage and after the endurance test, background fogging did not occur, and condition of thin layer of toner remained good, resulting in the formation of high quality images under all of tested environments of normal temperature normal humidity, high temperature high humidity, and low temperature low humidity.

From result of the tests, it was ascertained that there is a tendency that, the smaller the average grain size of magnetic powder is, the smaller the charge amount of toner at the initial stage is, and that, on the contrary, the larger the average grain size of magnetic powder is, the larger the charge amount of toner is after the endurance printing particularly under low temperature low humidity environment. According to the results, it is ascertained that average grain size of magnetic toner is preferable to be 0.05-0.35 μm, more preferably 0.15-0.30 μm.

<<Investigation Concerning the Shape of Magnetic Powder Grain for External Addition VII>>

### FIFTEENTH-EIGHTEENTH EMBODIMENTS, AND COMPARATIVE EXAMPLE 23-24

Six kinds of magnetic toner of volume base central particle diameter of 8.0 μm were prepared similarly as the tenth embodiment was prepared using the same amount of magnetic powder consisting of magnetite of the same composition as was in the tenth embodiment and same in grain shape but different in average grain size one another. Grain shape of magnetic powder used was a convex octahedron surrounded with 8 triangles with apexes and ridges being rounded to be formed into curved surfaces such that portions deemed as straight lines remain on the circumference of the projected figure of the grain. Volume specific resistance of magnetic powder was 4×10¹ Ωcm for comparative example 23, 3×10² Ωcm for the fifteenth embodiment, 4×10⁴ Ωcm for the sixteenth embodiment, 8×10⁷ Ωcm for the seventeenth embodiment, 1×10⁹ Ωcm for the eighteenth embodiment, and 6×10¹⁰ Ωcm for comparative example 24.

Magnetic single-component toner for developing electrostatic latent images was obtained by adding silica ((RA-200H of Japan Aerosil Co. made) of 1.0 parts by weight and titanium oxide (EC-100 of Titanium Inds. Co. made) of 2.0 parts by weight to 100 parts by weight of each of the toner of the embodiments and comparative examples and mixing by a Henschel mixer.

Using these developing agents and performing printing by a Kyocera made Page Printer FS-3830 installed with an a-Si photoreceptor under normal temperature normal humidity, initial image characteristic and durability were evaluated and at the same time adhered condition of thin toner layer and background fogging were was checked by eyes, and charge characteristic was measured. A developing sleeve made of SUS 305 was used of which surface roughness Rz was 4.0 μm.

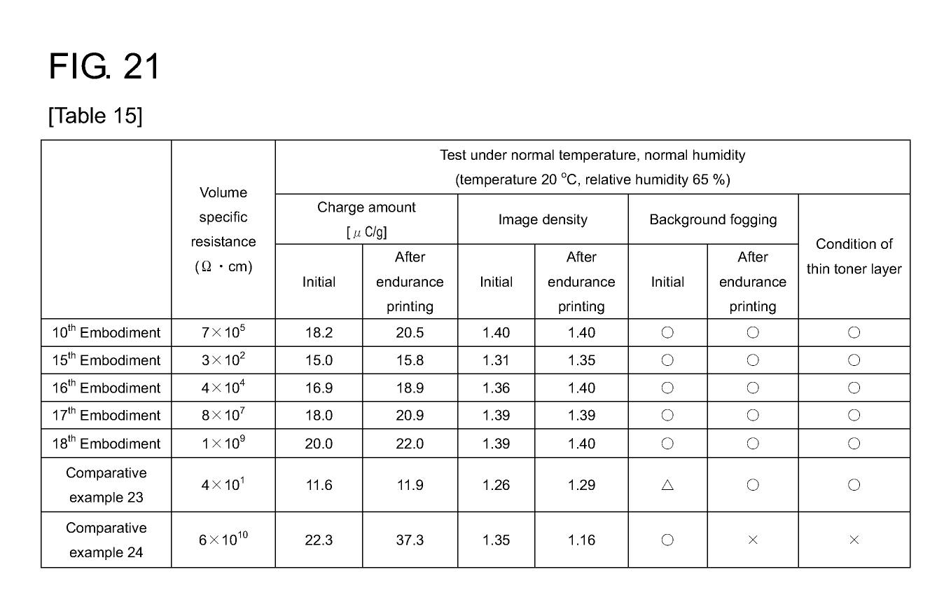

Results are shown in Table 15 of FIG. 21 together with the result of the tenth embodiment.

As can be recognized from Table 15, in the cases of toner of the tenth and fifteenth-eighteenth embodiments of which volume specific resistances were in a range of 3×10²-1×10⁹ Ωcm, state of charge amount, image density, and background fogging were all good, and also adhered condition of thin toner layer on to the surface of the developing sleeve was good. On the contrary, in the case of toner of comparative example 23 of which volume specific resistance was small as 4×10¹ Ωcm, although adhered condition of thin toner layer on to the surface of the developing sleeve was good but background fogging occurred on the same ground as that in the case of toner of comparative example 9. In the case of tone of comparative example 24 of which volume specific resistance was large as 6×10¹⁰ Ωcm, disturbance occurred in the thin layer of toner and background fogging occurred in the state of after-duration. Accordingly, it is ascertained that volume specific resistance of magnetic powder is preferable to be in a range of 10²-10⁹ Ωcm, more preferably 10³-10⁸ Ωcm, further preferably 10⁴-10⁷ Ωcm.

<<Investigation Concerning the Shape of Magnetic Powder Grain for External Addition VIII>>

### COMPARATIVE EXAMPLE 25-28

External additives other than magnetic powder were investigated for comparison. Toner of comparative examples 25-28 were prepared using as external additive titanium oxide of volume specific resistance of 7×10⁵ Ωcm (comparative example 25), titanium oxide of 8×10⁷ Ωcm (comparative example 26), zinc oxide of 7×10⁵ Ωcm (comparative example 27), and zinc oxide of 8×10⁷ Ωcm (comparative example 28). Toner of comparative examples 25-28 of volume base central particle diameter of 8.0 μm were prepared using the same amount of these external additives as abrasive powder in the same manner as the toner of the tenth or seventeenth embodiment was prepared.

Magnetic single-component toner for developing electrostatic latent images was obtained by adding silica ((RA-200H of Japan Aerosil Co. made) of 1.0 parts by weight and titanium oxide (EC-100 of Titanium Inds. Co. made) of 2.0 parts by weight to 100 parts by weight of each of the toner of the embodiments and comparative examples and mixing by a Henschel mixer.

Using these developing agents and performing printing by a Kyocera made Page Printer FS-3830 installed with an a-Si photoreceptor under normal temperature normal humidity, condition of thin toner layer on the surface of the developing sleeve and adhered condition of external additive onto the surface of toner particles were observed. A developing sleeve made of SUS 305 was used of which surface roughness Rz was 4.0 μm.

(Condition of Thin Toner Layer)

After an original of ISO 4% is printed on 100 thousand sheets continuously, condition of thin toner layer was checked by eyes and evaluated by following criteria:
∘: Thin layer is formed uniformly without irregularity.
□: Thicker part or parts are observed.
x: Uneveness in thickness is observed.

(Observation of Adhesion of External Additive Onto the Surface of Toner Particle)

After the original of ISO 4% was printed on 300 thousand sheets continuously, the toner was observed by a scanning electron microscope, and adhesion of external additive onto the surfaces of toner particles was evaluated by following criteria:
∘: Adhered condition of external additive onto toner particle surfaces is the same at the initial condition.
□: The external additive is peeled off slightly compared with the initial condition.
x: Almost all of the external additive is peeled off compared with the initial condition.

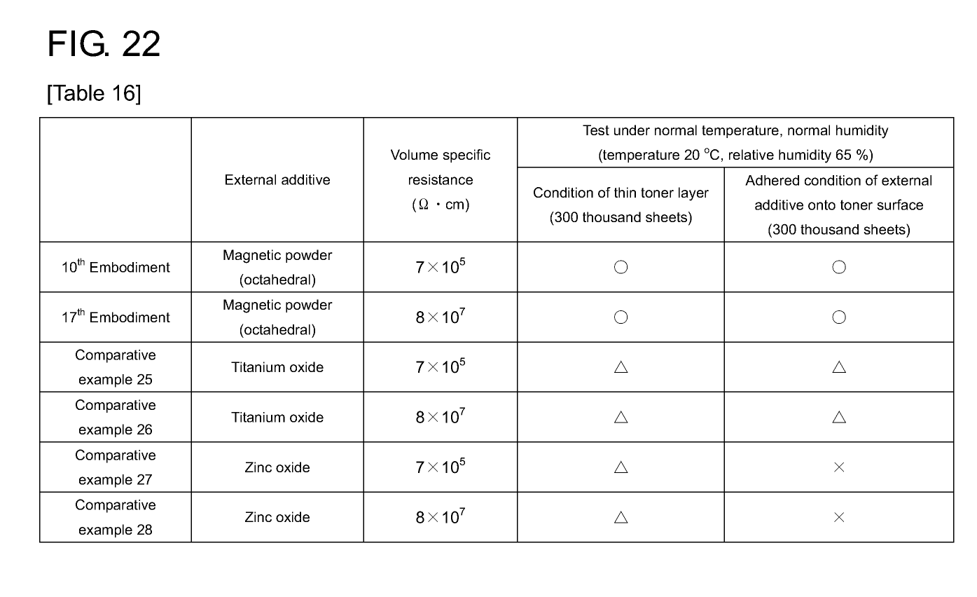

Results are shown in Table 16 of FIG. 22 together with the result of the tenth embodiment.

It can be recognized from Table 16 that, in the cases of comparative examples 25-28 in which toner is externally added with non-magnetic inorganic metal powder, adhesion of the external additive onto the toner particle is weak due to absence of magnetic force, so the external additive peeled off from the surface of toner particle during repeated use and initial adhesion could not be maintained, causing problems in the condition of thin layer of toner on the surface of the developing sleeve, condition of adhesion of magnetic powder onto the toner particle. On the contrary, in the case toner is externally added with magnetic powder having magnetic force, the external additive tends to be retained on the surface of toner particle by virtue of the magnetic force for a long period, as a result, the initial condition of adhesion of toner onto the toner particle was maintained until after the endurance printing.

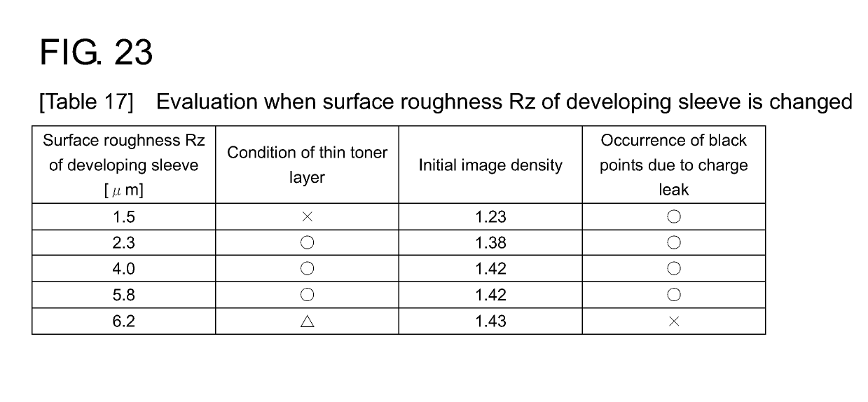

Condition of thin layer of toner, initial image density, and occurrence of black points due to charge leak were evaluated when surface roughness Rz of the developing sleeve was changed, using toner of the tenth embodiment. Results are shown in Table 17 of FIG. 23. Evaluation of black points was carried out by printing white by the Page Printer at initial stage under normal temperature normal humidity (20 □, 65% RH) and counting the number of black points larger than 0.1 mm in diameter. Occurrence of black points was evaluated by following criteria:
∘: No black point is observed.
□: Number of black point was smaller than 5.
x: Number of black point was 5 or larger.

It can be recognized from Table 17 that surface roughness Rz of the developing sleeve is most suitable to be in a range of 2.0 or larger and smaller than 6.0 in order that the formation of thin toner layer is not disturbed and black points due to charge leak does not occur.

### NINTEENTH EMBODIMENT

Further, in order to investigate with what disengagement rate of externally added magnetic powder can good result of image formation be obtained, a positive charge type magnetic single-component developing agent was prepared by adding titanium oxide (ST-100 of Titanium Inds. Co. made) of 2.0 parts by weight, silica (RA-200H of Japan Aerosil Co. made) of 1.0 parts by weight, and the magnetic powder of 1.0 parts by weight as an external additive were added to 100 parts by weight of the mother particles of magnetic toner prepared in the first embodiment, the magnetic powder being of octahedral grain shape with apexes and ridges being rounded to be formed into curved surfaces such that portions deemed as straight lines remain on the circumference of the projected figure of the grain, mixing them in a Henschel mixer (FM10C/1 of Mitsui-Miike Cemical Inds, made) at rotation speed of 3000 rpm and for 4 minutes of agitation to allow the magnetic powder to adhere onto the surfaces of the magnetic toner particles. This toner is referred to toner of 19^{th} embodiment.

Disengagement rate of magnetic powder against the mother particles in this toner was 15.6%. The magnetic powder used for external addition was of octahedral grain shape with apexes and ridges being rounded to be formed into curved surfaces such that portions deemed as straight lines remain on the circumference of the projected figure of the grain, and its average grain size was 0.2 μm.

### TWENTIETH TO TWENTY-SECOND EMBODIMENTS

Toner of 20^{th} to 22^{nd} embodiments were prepared by the same manner as the toner of 19^{th} embodiment was prepared, using magnetic powder of the same grain shape as used in the toner of 19^{th} embodiment. Toner of 20^{th} embodiment of disengagement rate of 10.7% was obtained by externally adding the same amount of the magnetic powder of average grain size of 0.20 μm, which size is the same to that in the case of 19^{th} embodiment, and rotating the Henschel mixer at 3500 rpm for 5 minutes, and toner of 21^{th} embodiment of disengagement rate of 24.1% was obtained by externally adding the same amount of the magnetic powder of average grain size of 0.20 μm and externally by rotating the Henschel mixer at 2000 rpm for 4 minutes, and further toner of 22^{th} embodiment of disengagement rate of 21.0% was obtained by externally adding the magnetic powder of which average grain size was 0.22 μm by rotating the Henschel mixer at 2000 rpm for 5 minutes.

### COMPARATIVE EXAMPLE 29

Toner of comparative example 29 of disengagement rate of 13.3% was prepared by the same manner as the toner of 19^{th} embodiment was prepared, by externally adding the same amount of magnetic powder of concave octahedral grain shape surrounded with 8 triangles with apexes and ridges not rounded instead of the magnetic powder used in the case of the 19^{th} embodiment and of average grain size of 0.22 μm by rotating the Henschel mixer at 3000 rpm for 4 minutes.

### COMPARATIVE EXAMPLE 30

Toner of comparative example 20 of disengagement rate of 14.2% was prepared by the same manner as the toner of 19^{th} embodiment was prepared, by externally adding the same amount of magnetic powder of concave octahedral grain shape surrounded with 8 triangles with apexes and ridges chamfered to be formed into flat faces smaller than the original surfaces of the octahedron as shown in FIG. 6(b) of Japanese Laid-Open Patent Application No. 2000-162817 instead of the magnetic powder used in the case of the 19^{th} embodiment and of average grain size of 0.20 μm by rotating the Henschel mixer at 3000 rpm for 4 minutes.

### COMPARATIVE EXAMPLE 31

Toner of comparative example 31 of disengagement rate of 12.1% was prepared by the same manner as the toner of 19^{th} embodiment was prepared, by externally adding the same amount of magnetic powder of cubic grain shape instead of the magnetic powder used in the case of the 19^{th} embodiment and of average grain size of 0.22 μm by rotating the Henschel mixer at 3000 rpm for 4 minutes.

### COMPARATIVE EXAMPLE 32

Toner of comparative example 32 of disengagement rate of 14.9% was prepared by the same manner as the toner of 19^{th} embodiment was prepared, by externally adding the same amount of magnetic powder of cubic grain shape with apexes and ridges chamfered to be formed into flat faces smaller than the original surfaces of the cube as shown in FIG. 6(f) of Japanese Laid-Open Patent Application No. 2000-162817 instead of the magnetic powder used in the case of the 19^{th} embodiment and of average grain size of 0.20 μm by rotating the Henschel mixer at 3000 rpm for 4 minutes.

### COMPARATIVE EXAMPLE 33

Toner of comparative example 33 of disengagement rate of 18.0% was prepared by the same manner as the toner of 19^{th} embodiment was prepared, by externally adding the same amount of magnetic powder of spherical grain shape instead of the magnetic powder used in the case of the 19^{th} embodiment and of average grain size of 0.22 μm by rotating the Henschel mixer at 3000 rpm for 4 minutes.

### COMPARATIVE EXAMPLE 34

Toner of comparative example 34 of disengagement rate of 8.8% was prepared by the same manner as the toner of 19^{th} embodiment was prepared, by externally adding the same amount of magnetic powder of octahedral grain shape with apexes and ridges rounded (same to the grain shape used in the 19^{th} embodiment) and of average grain size of 0.22 μm, by rotating the Henschel mixer at 3700 rpm for 6 minutes.

### COMPARATIVE EXAMPLE 35

Toner of comparative example 35 of disengagement rate of 26.5% was prepared by the same manner as the toner of 19^{th} embodiment was prepared, by externally adding the same amount of magnetic powder of octahedral grain shape with apexes and ridges rounded (same to the grain shape used in the 19^{th} embodiment) and of average grain size of 0.20 μm, by rotating the Henschel mixer at 1800 rpm for 3 minutes.

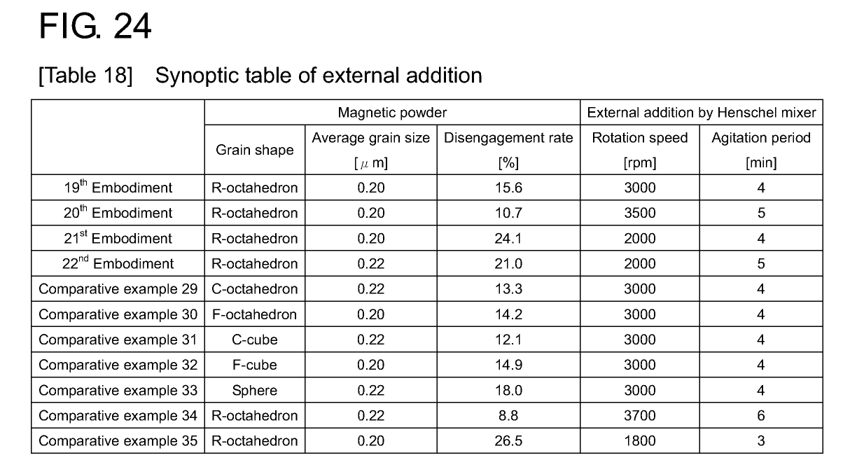

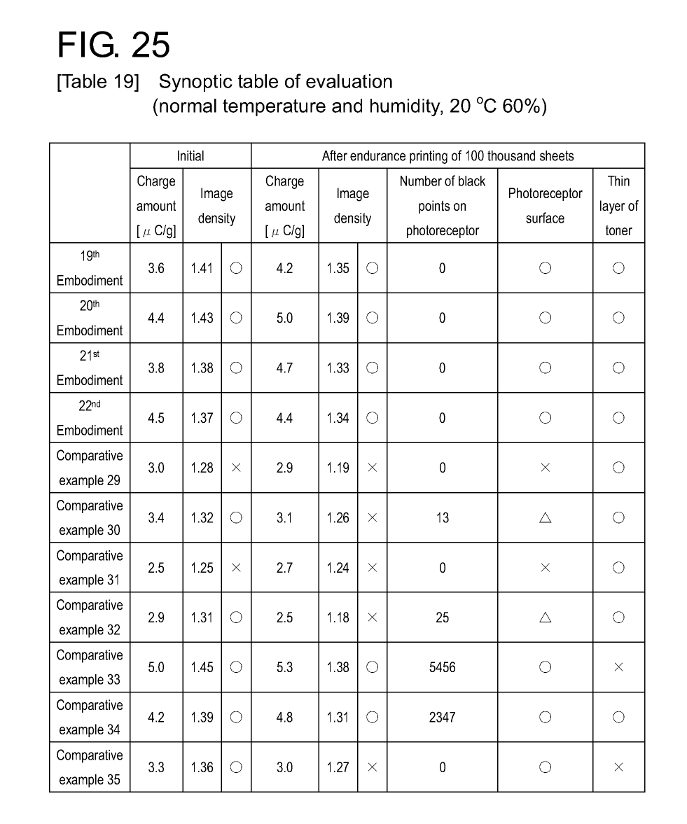

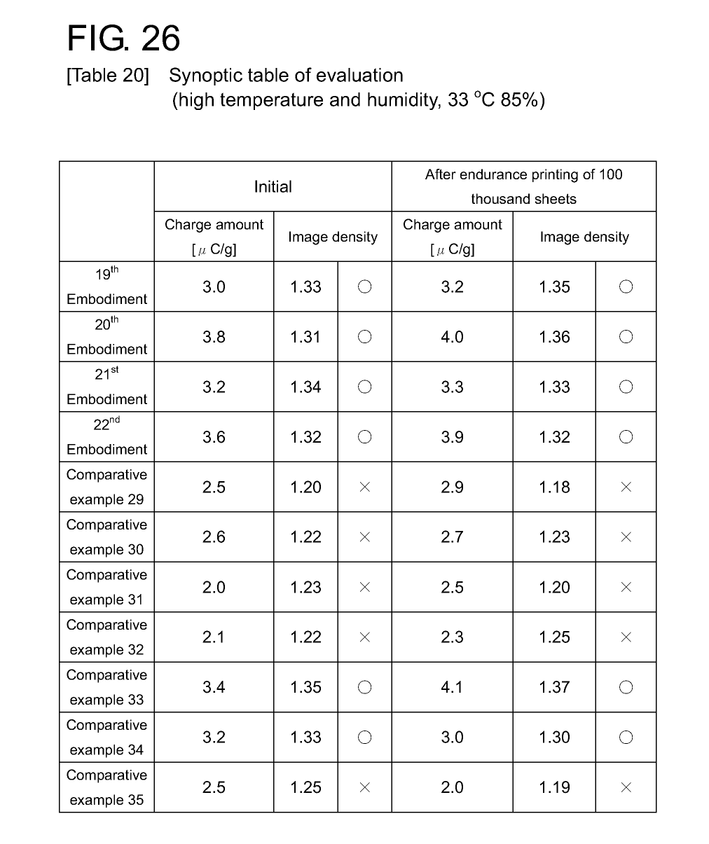

Using these developing agents and performing continuous printing (print rate of 5%) of 100 thousand sheets by a Kyocera made Page Printer FS-3820N under normal temperature normal humidity (20 □, 65% RH), condition of dielectric breakdown and surface condition of the photoreceptor, condition of thin layer of toner on the surface of the developing sleeve, image characteristic, charge characteristic of the developer were evaluated. Also printing (print rate of 5%) of 100 thousand sheets was carried out continuously under high temperature high humidity (33 □, 85% RH) and image characteristic was evaluated. Grain shape of magnetic powder used and disengagement rate of toner obtained were shown in Table 18 of FIG. 24, and results of evaluation are shown in Table 19 of FIG. 25 and Table 20 of FIG. 26.

(Condition of Dielectric Breakdown of Photoreceptor)

Number of occurrence of dielectric breakdown was evaluated by counting using a dot analyzer (DA-5000S of Ouji Manufacture Co. made) number of black points on recording sheets, which black point occurs due to dielectric breakdown on the photoreceptor, after 100 thousand sheets were printed by the Page Printer. Measurement range of black points was 5 mm×210 mm on sheets of A4 size in lateral direction.

(Surface of Photoreceptor)

After 100 thousand sheets was printed continuously on 100 thousand sheets, the photoreceptor was observed with eyes and scratches on the surface of the photoreceptor drum was evaluated by following criteria:
∘: No scratch is observed.
□: Very micro scratches are observed.
x: scratches are observed apparently.

(Condition of Thin Toner Layer)

After 100 thousand sheets were printed continuously, condition of thin toner layer on the surface of the developing sleeve was checked by eyes and evaluated by following criteria:
∘: Thin layer is formed uniformly without irregularity.
□: Thicker part or parts are observed, the layer is uneven on some parts (partially uneven).
x: Uneveness in thickness and adhesion on the surface of the sleeve were observed (defective thin layer formation).

(Image Characteristic)

An image evaluation pattern was printed by the Page Printer at the initial stage and then after 100 thousand sheets were printed under normal temperature normal humidity (20 □, 65% RH). Image density of each of printed images was measured by the Macbeth densitometer (RD914). Image density equal to or higher than 1.3 was evaluated as acceptable.

(Charge Characteristic)

Charge amount of toner on the surface of the magnetic toner carrying body 14₁ (developing sleeve) was measured by the charge measuring instrument (Q/M meter 210HS of TREK Co. made), and charge amount per 1 g of developer (μC/g) was obtained from the change of weight. Charge amount was measured at the initial stage and after endurance printing.

As shown in Table 19 of FIG. 25 and in Table 20 of FIG. 26, in the cases of 19^{th} to 22^{nd} embodiments, grain shape of externally added magnetic powder is of basically convex octahedral surrounded with 8 triangles with apexes and ridges being rounded to be formed into curved surfaces, and disengagement rate are in a range between 10.7-24.1%, so there occurred completely no problems concerning any of image characteristic, dielectric breakdown of the photoreceptor, and condition of thin layer of toner. This was the same under high temperature high humidity environment and reduction in image density did not occur.

On the contrary, in the case of toner of comparative example 29 in which magnetic powder of octahedral grain shape with apexes and ridges rounded not rounded was used, in the case of toner of comparative example 30 in which magnetic powder of octahedral grain shape with apexes and ridges chamfered to be formed into small flat surfaces, in the case of toner of comparative example 31 in which magnetic powder of cubic grain shape, and in the case of toner of comparative example 32 in which magnetic powder of cubic shape with apexes and ridges chamfered to be formed into small flat surfaces, grains of magnetic powder have pointed apexes and sharp ridges, so charge leak occurred from the pointed apexes and sharp ridges, resulting in small amount of charge retained by the toner which caused reduction in image density. This is particularly remarkable under high temperature high humidity environment, and in addition, scratches were observed on the surface of the photoreceptor after endurance printing.

In the case of toner of toner of comparative example 33 in which magnetic powder of spherical grain shape was used, although magnetic powder of spherical grain was added externally, dielectric breakdown occurred on the photoreceptor and in addition, defective formation of thin layer of toner arose.

Further, although magnetic powder of basically convex octahedral grain shape with apexes and ridges rounded was added externally in the cases of comparative examples 34 and 35, in the case of toner of comparative example 34 of disengagement rate as low as 8.8%, dielectric breakdown occurred because of low disengagement rate, and in the case of toner of comparative example 35 of disengagement rate as high as 26.5%, adhesion of toner onto the surface of the developing sleeve and defective formation of thin layer of toner arose because of too high disengagement rate. In addition, reduction in image density due to reduction in charge amount occurred, and this tendency was remarkable particularly under high temperature high humidity environment.

From these results, it is recognized that the magnetic powder to be externally added in the magnetic single-component toner of the present invention is preferable to be of basically octahedral grain shape with apexes and ridges being rounded to be formed into curved surfaces such that portions deemed as straight lines remain on the circumference of the projected figure of the grain and of average grain size in a range of 0.01-0.50 μm and of volume specific resistance in a range of 10²-10⁹ Ωcm, more preferably 10³-10⁸ Ωcm, further preferably 10⁴-10⁷ Ωcm.

The image forming apparatus for forming images by using the magnetic single-component toner externally added with this magnetic powder is most suitable to be constructed such that an a-Si layer of thickness equal to or smaller than 30 μm is used as the photoreceptor to carry the latent image, the latent image carrying body is cleaned with an elastic blade, and the toner is transferred by the rotation of the developing sleeve which has a magnetic roller inside thereof and roughened outer circumference surface, whereby formation of thin layer of toner on the surface of the developing sleeve is performed by allowing the toner on the surface of the developing sleeve to pass through a gap between the magnetic blade and the surface of the developing sleeve, i.e. magnetic single-component toner jumping type developing method, and 10 points average roughness Rz of the surface of the developing sleeve is preferable to be equal to or larger than 2.0 μm and smaller than 6.0 μm.

What is claimed is:

1. Magnetic single-component toner of which binder resin composing the toner contains at least magnetic powder is externally added on its surface with magnetic powder and which is retained on a developing sleeve surface for developing a latent image formed on a latent image carrying body by a magnetic toner jumping type developing method, said developing sleeve having a magnetic roller inside thereof and being disposed to face said latent image carrying body without contacting therewith, wherein said externally added magnetic powder is of polyhedral grain shape with apexes and ridges being rounded to be formed into curved surfaces such that portions deemed as straight lines remain on the circumference of the projected figure of the grain and has volume specific resistance of in a range of 10²-10⁹ Ωcm.

2. Magnetic single-component toner according to claim 1, wherein said magnetic powder contained in said binder resin is of spherical grain shape.

3. Magnetic single-component toner according to claim 1, wherein said externally added magnetic powder is of convex octahedral grain shape surrounded with 8 triangles with apexes and ridges being rounded to be formed into curved surfaces such that portions deemed as straight lines remain on the circumference of the projected figure of the grain.

4. Magnetic single-component toner according to claim 1, wherein said externally added magnetic powder is of average grain size of 0.01-0.50 μm.

5. Magnetic single-component toner according to claim 1, wherein said externally added magnetic powder is added by 0.1-5.0% by weight.

6. Magnetic single-component toner of which binder resin composing the toner contains at least magnetic powder is externally added on its surface with magnetic powder for developing a latent image formed by an electrographic process on an amorphous silicon photoreceptor onto the surface against which an elastic blade is pressed for cleaning the toner remaining on the surface, wherein said externally added magnetic powder is basically of convex octahedral grain shape surrounded with 8 triangles with apexes and ridges being rounded to be formed into curved surfaces such that portions deemed as straight lines remain on the circumference of the projected figure of the grain and disengagement rate of said externally added magnetic powder is 10-25%.

7. Magnetic single-component toner according to claim 6, wherein said magnetic powder contained in said binder resin is of spherical grain shape.

8. Magnetic single-component toner according to claim 6, wherein said externally added magnetic powder is of average grain size of 0.01-0.50 μm.

9. Magnetic single-component toner according to claim 6, wherein said externally added magnetic powder is added by 0.1-5.0% by weight.

10. A developing unit having a developing sleeve for carrying magnetic single-component toner of which binder resin composing the toner contains at least magnetic powder is externally added on its surface with magnetic powder of octahedral grain shape with apexes and ridges being rounded to be formed into curved surfaces such that portions deemed as straight lines remain on the circumference of the projected figure of the grain and has volume specific resistance of in a range of 10²-10⁹ Ωcm, said developing sleeve having a magnetic roller inside thereof and being disposed to face a latent image carrying body on which a latent image is formed without contacting therewith and being finished to have 10 points average surface roughness equal to or larger than 2 μm and smaller than 6.0 μm, whereby said latent image formed by an electrographic process on said latent image carrying body is developed by magnetic toner jumping type developing method.

11. Adeveloping unit according to claim 10, wherein said latent image carrying body has an amorphous silicon photoreceptor of film thickness of 10-30 μm.

12. An image forming apparatus comprising a latent image carrying body having an amorphous silicon photoreceptor, a toner having a magnetic roller inside thereof and disposed to face said latent image carrying body without contacting therewith and rotating with magnetic single-component toner retaining on the surface thereof, a means for allowing a toner image to be formed on the surface of said latent image carrying body by allowing said magnetic single-component toner to jump toward said latent image, and a cleaning means using an elastic blade pressed against the surface of the latent image carrying body for cleaning the toner remaining on the surface after the toner image is transferred onto a recording medium, wherein said magnetic single-component toner of which binder resin composing the toner contains at least magnetic powder is externally added on its surface with magnetic powder of basically polyhedral shape with apexes and ridges being rounded to be formed into curved surfaces such that portions deemed as straight lines remain on the circumference of the projected figure of the grain so that disengagement rate of said magnetic powder is 10-25%.

13. An image forming apparatus according to claim 12, wherein said magnetic toner added externally to said magnetic single-component toner is of volume specific resistance of in a range of 10²-10⁹ Ωcm, and a developing sleeve of said toner carrying body is finished to have 10 points average surface roughness equal to or larger than 2 μm and smaller than 6.0 μm.

14. An image forming apparatus according to claim 12, wherein said latent image carrying body has an amorphous silicon photoreceptor of film thickness of 10-30 μm.
